(19) United States
(12) Patent Application Publication
(10) Pub. No.: US 2010/0265349 A1
(43) Pub. Date: Oct. 21, 2010

(54) DIGITAL CAMERA MODULE

(75) Inventors: Jin Tae KIM, Daejeon (KR); Jung Jin Ju, Daejeon (KR); Suntak Park, Daejeon (KR); Seung Koo Park, Daejeon (KR); Min-su Kim, Daejeon (KR)

Correspondence Address: RABIN & Berdo, PC, 1101 14TH STREET, NW, SUITE 500, WASHINGTON, DC, 20005, US

(73) Assignee: ELECTRONICS AND TELECOMMUNICATIONS RESEARCH INSTITUTE, Daejeon (KR)

(21) Appl. No.: 12/648,096

(22) Filed: Dec. 28, 2009

(30) Foreign Application Priority Data
Apr. 17, 2009 (KR) 10-2009-0033610
Aug. 17, 2009 (KR) 10-2009-0075825

(51) Int. Cl. H04N 5/225; H04N 5/335; H04B 10/02; H04B 10/12; G06F 13/14; G02B 6/00

(52) U.S. Cl. 348/222.1; 348/294; 398/139; 398/141; 345/519; 385/141; 348/333.11; 348/E05.024; 348/E05.091

(57) ABSTRACT

Provided is a digital camera module. The digital camera module includes an image sensor generating an electrical signal including a video signal and a clock signal and an optical interconnection unit converting the at least one of the video and clock signals into an optical signal to transmit the converted optical signal. The digital camera module further includes an image signal processor receiving the video signal restored from the optical signal to the electrical signal to convert the received video signal into a signal that is visually displayable.

### CROSS-REFERENCE TO RELATED APPLICATIONS

This U.S. non-provisional patent application claims priority under 35 U.S.C. §119 of Korean Patent Application Nos. 10-2009-0033610, filed on Apr. 17, 2009, and 10-2009-0075825, filed on Aug. 17, 2009, the entire contents of which are hereby incorporated by reference.

### BACKGROUND

The present disclosure herein relates to a camera module, and more particularly, to a digital camera module with an optical interconnection.

Portable-phones and/or cameras now require a resolution of five million pixels or more and high display performance having a frame rate of 15 frame/sec or more in Full HD. An image sensor of a digital camera module used for realizing the high resolution and performance transmits a large-capacity high-speed video signal having pixel information to an image signal processor (ISP) through an electrical interconnection. However, in data transmission using the existing electrical communication, as a distance between the image sensor and the ISP increases, the transmission speed and capacity of an video signal are limited due to limitations of the electrical interconnection such as crosstalk, electromagnetic interface (EMI), electromagnetic compatibility (EMC), and transmission losses.

### SUMMARY

Embodiments of the inventive concept provide a digital camera module that may transmit a signal at a high speed and with large capacity to overcome limitations of signal transmission.

The inventive concept provides a digital camera module including an optical interconnection unit converting an electrical signal into an optical signal to transmit the converted optical signal.

Embodiments of the inventive concept provide digital camera modules including: an image sensor generating an electrical signal including a video signal and a clock signal; and an optical interconnection unit converting the at least video signal of the video and clock signals into an optical signal to transmit the converted optical signal.

In some embodiments, the optical interconnection unit may include: an optical waveguide providing a transmission path of the optical signal; an optical transmitting part converting the at least video signal of the video and clock signals into the optical signal to transmit the converted optical signal to the optical waveguide; and an optical receiving part restoring the optical signal transmitted from the optical waveguide to the electrical signal.

In other embodiments, the digital camera modules may further include an image signal processor receiving the signal restored from the optical signal to the electrical signal to convert the received signal into a signal that is visually displayable.

In still other embodiments, the optical transmitting part and the optical receiving part may have module type structures separably coupled to the optical waveguide, respectively.

In even other embodiments, the optical interconnection unit may further include an electrical interconnection outside or inside the optical waveguide.

In yet other embodiments, the optical waveguide may include one of an optical fiber, a core-clad waveguide in which a dielectric is built in an organic or inorganic polymer optical material, and a metal wire waveguide in which a metal wire is built in the polymer optical material.

In further embodiments, the optical waveguide may be flexible.

In still further embodiments, the optical interconnection unit may include: a first optical transmitting part converting the video and clock signals into a first optical signal; a first optical receiving part restoring the first optical signal to a first electrical signal; a second optical transmitting part converting an operation signal of the image sensor into a second optical signal; and an optical waveguide providing a transmission path of the first and second optical signals,

In even further embodiments, the first optical transmitting part and the second optical receiving part may be disposed at one end of the optical waveguide, and the first optical receiving part and the second optical transmitting part may be disposed at the other end of the optical waveguide.

In yet further embodiments, the digital camera modules may further include: a display visually displaying an image obtained from the image sensor; and a display module including a semiconductor chip controlling an operation of the display.

In other embodiments of the inventive concept, digital camera modules include: an image sensor mounted on a board including an electrical connection part, the image sensor photographing an image to generate an electrical signal including a video signal and a clock signal; an image signal processor mounted on the board, the image signal processor converting the electrical signal into a signal that is visually displayable; and an optical interconnection unit mounted on the board, the optical interconnection unit converting the electrical signal into an optical signal to transmit the converted optical signal from the image sensor to the image signal processor.

In some embodiments, the optical interconnection unit may include: an optical transmitting part including a light source and a light source driver chip, the optical transmitting part receiving the video and clock signals from the image sensor to convert the received signals from the electrical signal to the optical signal; an optical waveguide providing a transmission path of the video and clock signals converted into the optical signal; and an optical receiving part including a light receiving device and a light receiving device driver chip, the optical receiving part restoring the video and clock signals converted into the optical signal to the electrical signal.

In other embodiments, the optical interconnection unit may further include: an optical transmitting connector allowing the optical transmitting part to be separably coupled to the optical waveguide; and an optical receiving connector allowing the optical receiving part to be separably coupled to the optical waveguide.

In still other embodiments, the board may include: a first electrical interconnection providing a transmission path of the video and clock signals from the image sensor to the optical interconnection unit; a second electrical interconnection providing a transmission path of the video and clock signals from the optical interconnection unit to the image signal processor; and a third electrical interconnection providing a transmission path of the video and clock signals from the image signal processor to the electrical connection part.

In even other embodiments, the optical interconnection unit may include: an optical transmitting part including a light source and a light source driver chip, the optical transmitting part receiving the video signal from the image sensor to convert the received signal from the electrical signal to the optical signal; an optical waveguide providing a transmission path of the video signal converted into the optical signal; and an optical receiving part including a light receiving device and a light receiving device driver chip, the optical receiving part restoring the video signal converted into the optical signal to the electrical signal.

In yet other embodiments, the board may include: a first electrical interconnection providing a transmission path of the video signal from the image sensor to the optical interconnection unit; a second electrical interconnection providing a transmission path of the video signal from the optical interconnection unit to the image signal processor; a third electrical interconnection providing a transmission path of the clock signal from the image sensor to the image signal processor; and a fourth electrical interconnection providing a transmission path of the video and clock signals from the image signal processor to the electrical connection part.

In further embodiments, the digital camera modules may further include a display module displaying an image photographed by the image sensor, wherein the display module may include: a display board including an electrical connector electrically connected to the electrical connection part; a display mounted on the display board, the display receiving the signal that is visually displayable from the image signal processor to display the signal; and a semiconductor chip mounted on the display board, the semiconductor chip controlling an operation of the display module.

In still other embodiments of the inventive concept, digital camera modules include: an image sensor mounted on a board including an electrical connection part, the image sensor photographing an image to generate an electrical signal including a video signal and a clock signal; and an optical interconnection unit mounted on the board, the optical interconnection unit converting the electrical signal into an optical signal to transmit the converted optical signal from the image sensor to the electrical connection part.

In some embodiments, the optical interconnection unit may include: an optical transmitting part including a light source and a light source driver chip, the optical transmitting part receiving the video and clock signals from the image sensor to convert the received signal from the electrical signal to the optical signal; an optical waveguide providing a transmission path of the video and clock signals converted into the optical signal; and an optical receiving part including a light receiving device and a light receiving device driver chip, the optical receiving part restoring the video and clock signals converted into the optical signal to the electrical signal.

In other embodiments, the board may include: a first electrical interconnection providing a transmission path of the video and clock signals from the image sensor to the optical interconnection unit; and a second electrical interconnection providing a transmission path of the video and clock signals from the optical interconnection unit to the electrical connection part.

In still other embodiments, the optical interconnection unit may include: an optical transmitting part including a light source and a light source driver chip, the optical transmitting part receiving the video signal from the image sensor to convert the received signal from the electrical signal to the optical signal and a light source driver chip; an optical waveguide providing a transmission path of the video signal converted into the optical signal; and an optical receiving part including a light receiving device and a light receiving device driver chip, the optical receiving part restoring the video signal converted into the optical signal to the electrical signal.

In even other embodiments, the board may include: a first electrical interconnection providing a transmission path of the video signal from the image sensor to the optical interconnection unit; a second electrical interconnection providing a transmission path of the video signal from the optical interconnection unit to the electrical connection part; and a third electrical interconnection providing a transmission path of the clock signal from the image sensor to the electrical connection part.

In yet other embodiments, the digital camera modules may further include a display module displaying an image photographed by the image sensor, wherein the display module may include: a display board including an electrical connector electrically connected to the electrical connection part; an image signal processor mounted on the display board, the image signal processor converting the video and clock signals into a signal that is visually displayable; a display mounted on the display board, the display receiving the signal that is visually displayable from the image signal processor to display the signal; and a semiconductor chip mounted on the display board, the semiconductor chip controlling an operation of the display module.

In even other embodiments of the inventive concept, digital camera modules include: an image sensor photographing an image to generate an electrical signal including a video signal and a clock signal; and an optical interconnection converting the electrical signal into an optical signal to provide a transmission path of the optical signal, wherein the optical interconnection unit includes: an optical waveguide providing a transmission path of the video and clock signals converted into the optical signal; an optical transmitting module including a light source and a light source driver chip, the optical transmitting module receiving the video and clock signals from the image sensor to convert the received signals from the electrical signal to the optical signal; and an optical receiving module including a light receiving device and a light receiving device driver chip, the optical receiving module restoring the video and clock signals converted into the optical signal to the electrical signal, wherein the optical transmitting and receiving modules are separably coupled to the optical waveguide.

In some embodiments, the optical waveguide may include: an optical interconnection providing a transmission path of the optical signal in the optical waveguide; and an electrical interconnection providing a transmission path of an electrical signal needed to operate the image sensor inside or outside the optical waveguide.

In other embodiments, the digital camera modules may further include a display module displaying an image photographed by the image sensor, wherein the display module may include: a display board including an electrical connector electrically connected to the optical receiving module; an image signal processor mounted on the display board, the image signal processor converting the video and clock signals into a signal that is visually displayable; a display mounted on the display board, the display receiving the signal that is visually displayable from the image signal processor to display the signal; and a semiconductor chip mounted on the display board, the semiconductor chip controlling an operation of the display module.

In yet other embodiments of the inventive concept, digital camera modules include: an image sensor receiving a first electrical signal and photographing an image to generate a second electrical signal including a video signal and a clock signal; and an optical interconnection unit including an optical transmitting part converting the electrical signals into optical signals, an optical receiving part restoring the optical signals to the electrical signals, and an optical waveguide providing a transmission path of the optical signals, wherein the optical transmitting part include a first optical transmitting part converting the first electrical signal into a first optical signal and a first optical receiving part restoring the first optical signal to the first electrical signal, and wherein the optical receiving part includes a second optical transmitting part converting the second electrical signal into a second optical signal and a second optical receiving part restoring the second optical signal to the second electrical signal.

In some embodiments, the first optical transmitting part and the second optical receiving part may be coupled to one end of the optical waveguide adjacent to the image sensor, and the first optical receiving part and the second optical transmitting part may be coupled to the other end of the optical waveguide.

In other embodiments, the digital camera modules may further include an image signal processor disposed adjacent to the other end of the optical waveguide to receive a signal restored from the second optical signal to the second electrical signal, thereby converting the received signal into a signal that is visually displayable.

In still other embodiments, the digital camera modules may further include: a display visually displaying an image photographed by the image sensor; and a display module including a semiconductor chip providing the first electrical signal to the image sensor to control an operation of the image sensor.

### BRIEF DESCRIPTION OF THE DRAWINGS

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the figures:

FIG. 1 is a block diagram illustrating an example of a digital camera module according to the inventive concept;

FIG. 2A is a plan view of a digital camera module according to a first embodiment of the inventive concept;

FIG. 2B is a perspective view of the digital camera module according to a first embodiment of the inventive concept;

FIG. 2C is a perspective view illustrating an example of an optical interconnection unit in the digital camera module according to the first embodiment of the inventive concept;

FIG. 2D is a sectional view illustrating an example of the optical interconnection unit in the digital camera module according to the first embodiment of the inventive concept;

FIG. 2E is a perspective view illustrating an optical waveguide of the optical interconnection unit in the digital camera module according to the first embodiment of the inventive concept;

FIG. 2F is a perspective view illustrating another example of the optical interconnection unit in the digital camera module according to the first embodiment of the inventive concept;

FIG. 2G is a sectional view illustrating another example of the optical interconnection unit in the digital camera module according to the first embodiment of the inventive concept;

FIG. 2H is a perspective view illustrating still another example of the optical interconnection unit in the digital camera module according to the first embodiment of the inventive concept;

FIG. 2I is a sectional view illustrating still another example of the optical interconnection unit in the digital camera module according to the first embodiment of the inventive concept;

FIG. 2J is a perspective view illustrating further still another example of the optical interconnection unit in the digital camera module according to the first embodiment of the inventive concept;

FIG. 2K is a sectional view illustrating further still another example of the optical interconnection unit in the digital camera module according to the first embodiment of the inventive concept;

FIG. 3A is a plan view of a digital camera module according to a second embodiment of the inventive concept;

FIG. 3B is a perspective view of the digital camera module according to the second embodiment of the inventive concept;

FIG. 4 is a perspective view of a digital camera module according to a third embodiment of the inventive concept;

FIG. 5 is a perspective view of a digital camera module according to a fourth embodiment of the inventive concept;

FIG. 6A is a plan view of a digital camera module according to a fifth embodiment of the inventive concept;

FIG. 6B is a perspective view of the digital camera module according to the fifth embodiment of the inventive concept;

FIG. 7A is a plan view of a digital camera module according to a sixth embodiment of the inventive concept;

FIG. 7B is a perspective view of the digital camera module according to the sixth embodiment of the inventive concept;

FIG. 8A is a plan view of a digital camera module according to a seventh embodiment of the inventive concept;

FIG. 8B is a perspective view of the digital camera module according to the seventh embodiment of the inventive concept;

FIG. 9A is a plan view of a digital camera module according to an eighth embodiment of the inventive concept;

FIG. 9B is a perspective view of the digital camera module according to the eighth embodiment of the inventive concept;

FIG. 9C is a perspective view illustrating another example of an optical interconnection unit in the digital camera module according to the eighth embodiment of the inventive concept;

FIG. 10A is a plan view of a digital camera module according to a ninth embodiment of the inventive concept;

FIG. 10B is a perspective view of the digital camera module according to the ninth embodiment of the inventive concept;

FIG. 11A is a plan view of a digital camera module according to a tenth embodiment of the inventive concept;

FIG. 11B is a perspective view of the digital camera module according to the tenth embodiment of the inventive concept;

FIG. 12A is a plan view of a digital camera module according to an eleventh embodiment of the inventive concept;

FIG. 12B is a perspective view of the digital camera module according to the eleventh embodiment of the inventive concept;

FIG. 13A is a plan view of a digital camera module according to a twelfth embodiment of the inventive concept;

FIG. 13B is a perspective view of the digital camera module according to the twelfth embodiment of the inventive concept;

FIG. 14A is a plan view of a digital camera module according to a thirteenth embodiment of the inventive concept;

FIG. 14B is a perspective view of the digital camera module according to the thirteenth embodiment of the inventive concept;

FIG. 15A is a plan view of a digital camera module according to a fourteenth embodiment of the inventive concept;

FIG. 15B is a perspective view of the digital camera module according to the fourteenth embodiment of the inventive concept;

FIG. 16A is a plan view of a digital camera module according to a fifteenth embodiment of the inventive concept; and

FIG. 16B is a perspective view of the digital camera module according to the fifteenth embodiment of the inventive concept.

### DETAILED DESCRIPTION OF THE EMBODIMENTS

Preferred embodiments of the inventive concept will be described below in more detail with reference to the accompanying drawings. The inventive concept may, however, be embodied in different forms and should not be construed as limited to the embodiments set forth herein. Rather, these embodiments are provided so that this disclosure will be thorough and complete, and will fully convey the scope of the inventive concept to those skilled in the art.

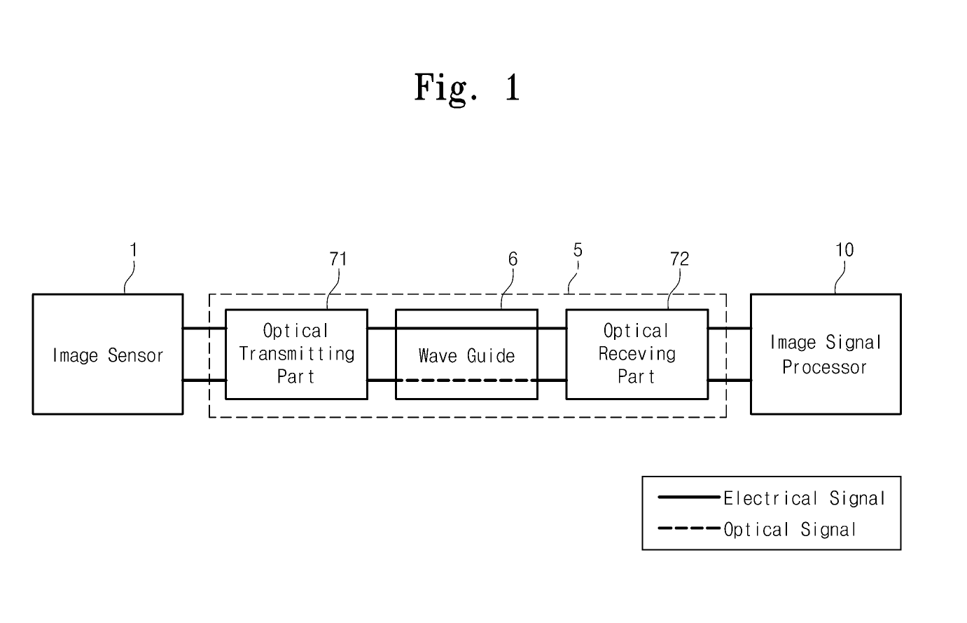

FIG. 1 is a block diagram illustrating an example of a digital camera module according to the inventive concept.

Referring to FIG. 1, a digital camera module according to the inventive concept may include an image sensor 1 that is an image capturing device, an image signal processor (ISP) 10 for converting a signal generated in the image sensor 1 into a signal that is visually displayable on a display such as a liquid crystal display, and an optical interconnection unit 5 for transmitting the signal generated in the image sensor 1 to the ISP 10.

In FIG. 1, a solid line represents a path of an electrical signal, and a dot line represents a path of an optical signal. The optical signal may be transmitted from the image sensor 1 to the ISP 10 via the optical interconnection unit 5. The electrical signal may be transmitted from the image sensor 1 to the ISP 10, may be via the optical interconnection unit 5 or not. For example, the electrical signal generated in the image sensor 1 may include a video signal and a clock signal. The video signal and the clock signal may be respectively separated and converted into an optical signal. Alternatively, the video signal and the clock signal may be mixed with each other and converted into an optical signal to transmit the converted optical signal through the optical interconnection unit 5. For another example, the video signal may be converted into an optical signal and transmitted through the optical interconnection unit 5, while the clock signal may be transmitted to the ISP 10 in a state where they are not converted into the optical signal. The clock signal that is not converted into the optical signal may be transmitted to the ISP 10 through the optical interconnection unit 5 or transmitted from the image sensor 1 to the ISP 10 without passing through the optical interconnection unit 5.

The optical interconnection unit 5 may include an optical transmitting part 71 converting an electrical signal into an optical signal, an optical waveguide 6 providing a transmission path of the optical signal, and an optical receiving part 72 restoring the transmitted optical signal to the electrical signal. The optical transmitting part 71 may include a light source and a semiconductor chip for a light source driver. The optical receiving part 72 may include a light receiving device and a semiconductor chip for a light receiving device driver. The optical transmitting part 71 and the optical receiving part 72 may be modulated and designed independently with the optical waveguide 6. The optical waveguide 6 may include an optical fiber or a metal wire, which provides a path of the optical signal. The optical interconnection unit 5 may further include an electrical interconnection, which provides a path of the electrical signal. The electrical interconnection may be disposed on an outer surface of the optical waveguide 6 or inside the optical waveguide 6.

The ISP 10 may be mounted on one board together with the image sensor 1 and the optical interconnection unit 5 or separately mounted on the other board. The ISP 10 may be designed into an independent chip or integrated with the other chip. Alternatively, the digital camera module of the inventive concept may not include the ISP 10. Here, the ISP 10 may be mounted on a board (e.g., a board for a display) different from the board on which the image sensor 1 and the optical interconnection unit 5 are mounted.

The image sensor 1 may photograph a certain object to generate an electrical signal including a video signal and a clock signal. The video signal and the clock signal may be separated from or mixed with each other and converted from an electrical signal into an optical signal in the optical transmitting part 71 to transmit the converted optical signal to the optical receiving part 72 through the optical waveguide 6. The optical signal transmitted to the optical receiving part 72 may be restored to an electrical signal to transmit the restored electrical signal to the ISP 10. The video signal and the clock signal transmitted to the ISP 10 may be converted into a signal that is visually displayable to realize images visible to naked eye on a device such as the liquid crystal display. An electrical signal needed to operate the image sensor 1 may be transmitted to the image sensor 1 through the optical waveguide 6 or may be detoured around the optical waveguide 6. Alternatively, the electrical signal needed to operate the image sensor 1 may be converted into an optical signal to transmit the converted optical signal through the optical waveguide 6. The above-mentioned signal processing is only one example and is not intended to limit the inventive concept in any way.

Various embodiments that can realize the digital camera module of the inventive concept will be described. It is noted that the embodiments below discloses examples of the inventive concept and are not intended to limit the inventive concept in any way. It will be understood by those of ordinary skill in the art that various changes in form and details may be made therein without departing from the spirit and scope of the present invention as defined by the following claims.

### First Embodiment

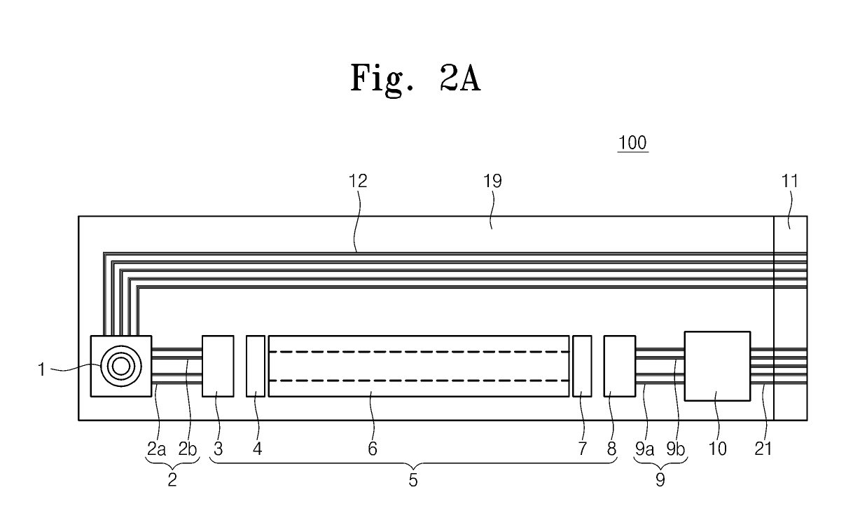

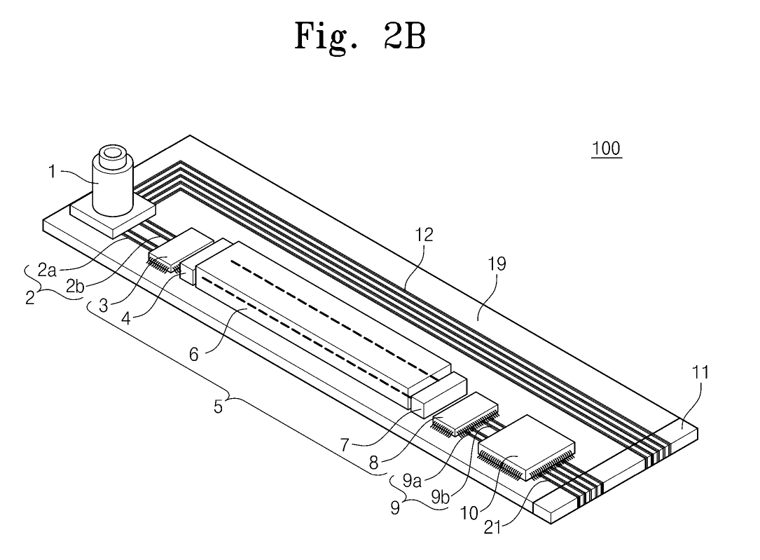

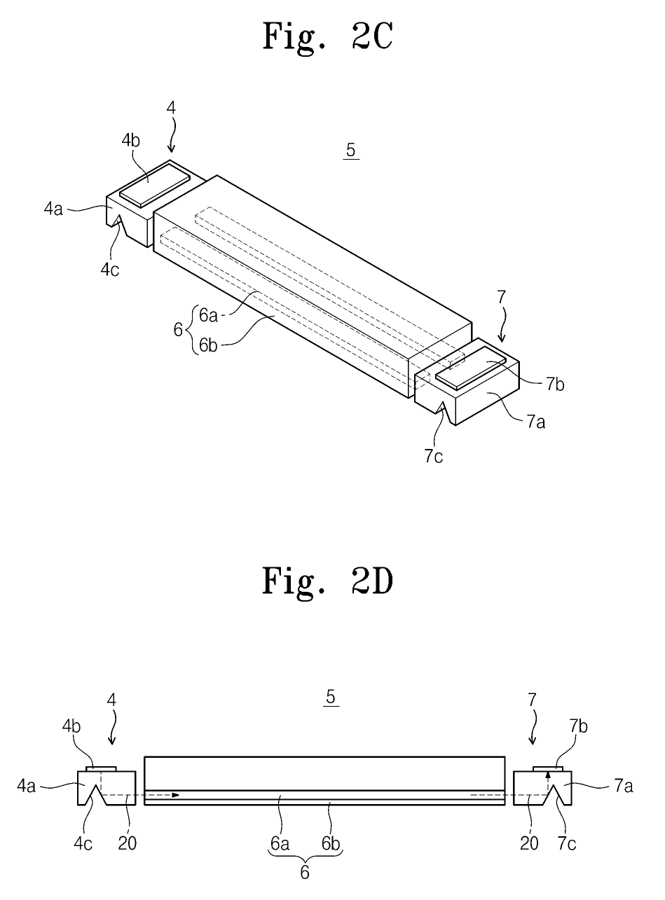

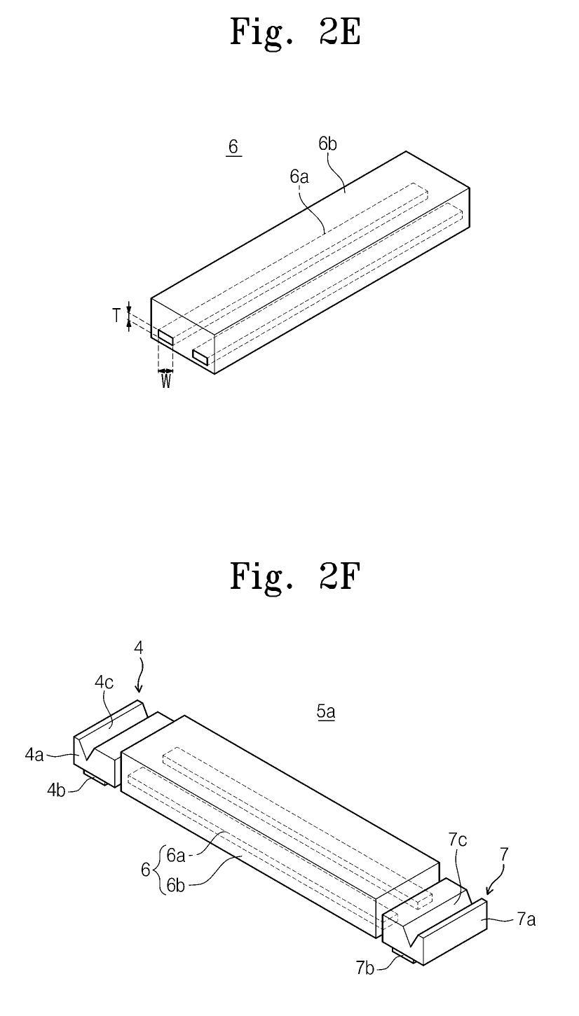

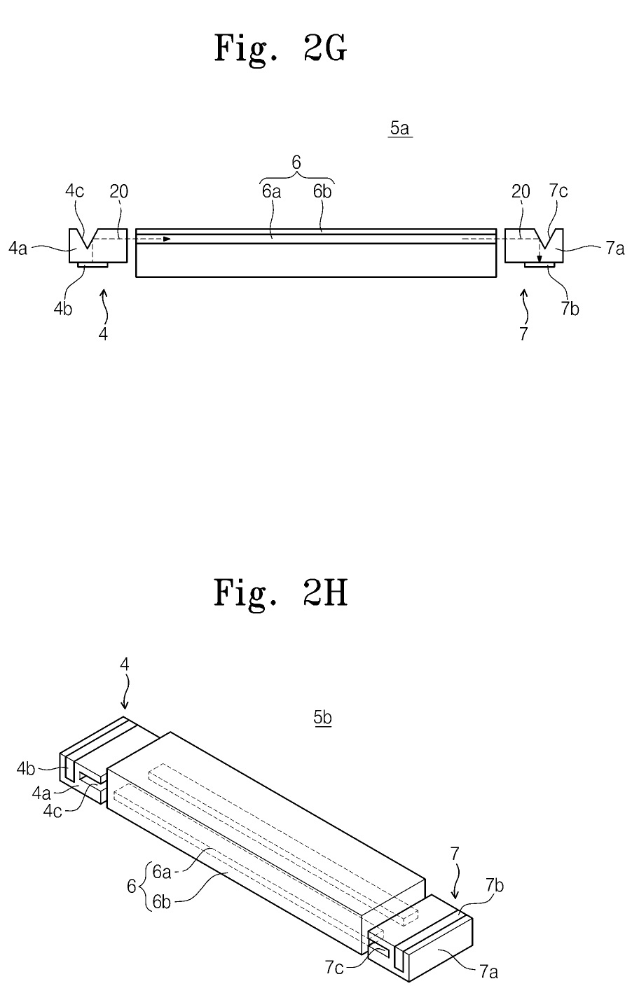

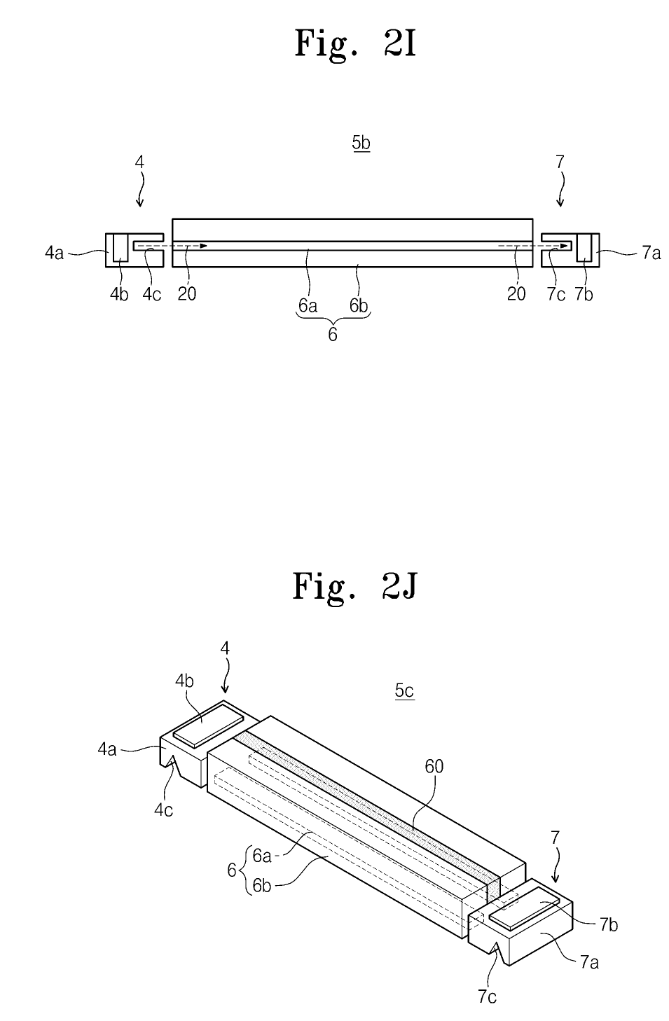

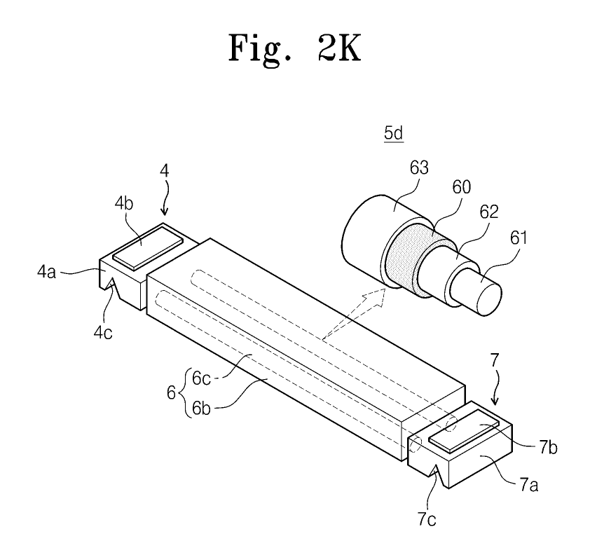

FIG. 2A is a plan view of a digital camera module according to a first embodiment of the inventive concept, and FIG. 2B is a perspective view of the digital camera module.

Referring to FIGS. 2A and 2B, a digital camera module 100 according to a first embodiment may include an image sensor 1, an optical interconnection unit 5 transmitting a signal generated in the image sensor 1, and a board 19 on which an image signal process (ISP) 10 converting the signal transmitted from the image sensor 1 through the optical interconnection unit 5 into a signal that is visually displayable on a monitor is mounted. The digital camera module 100 may be applicable to various electronic products such as a digital camera, a digital camera for a portable terminal such as cell-phone, PMP, MP3P, etc.

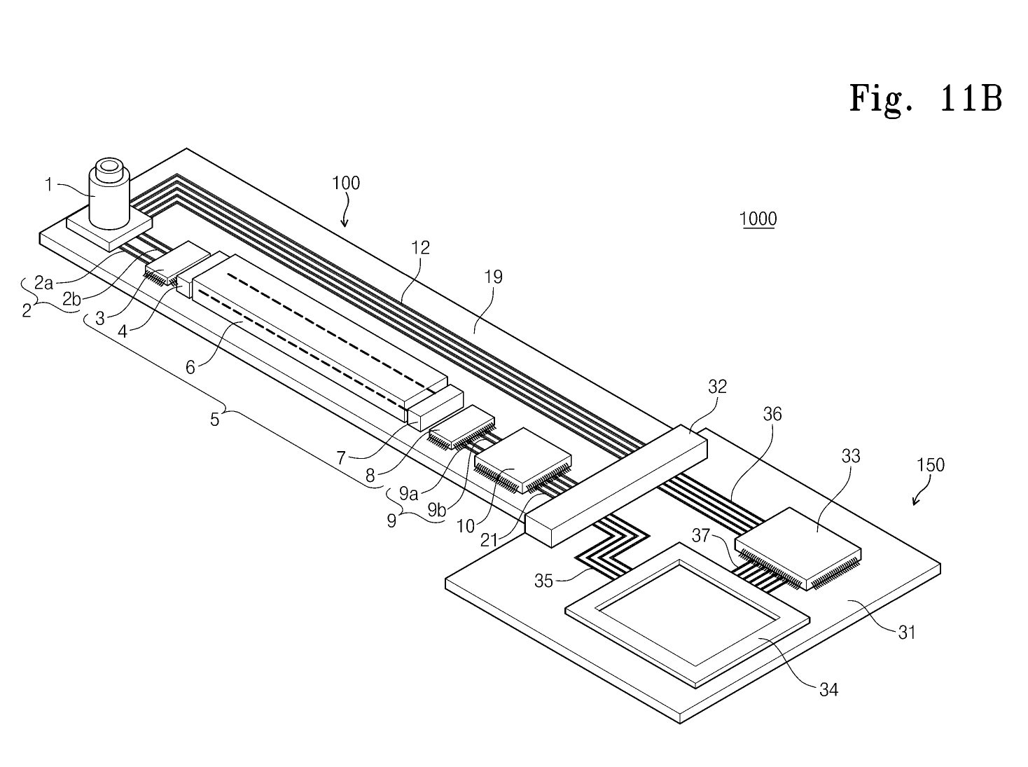

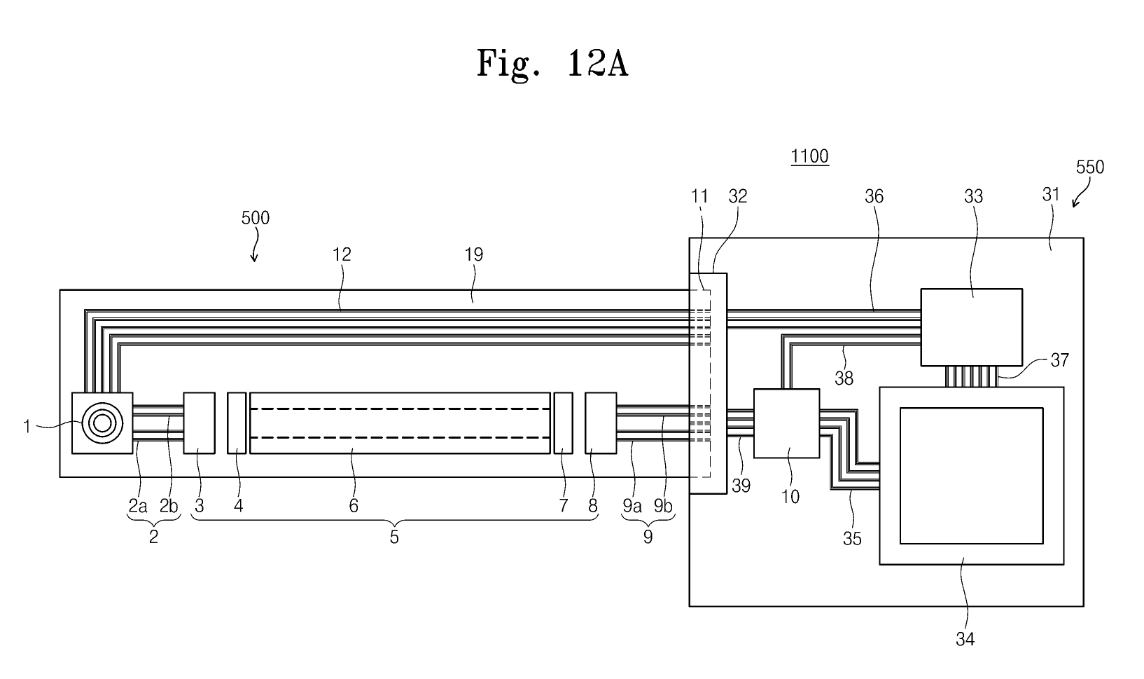

A first electrical interconnection 2, a second electrical interconnection 9, a third electrical interconnection 12, and a fourth electrical interconnection 21 may be disposed on the board 19. The first electrical interconnection 2 electrically connects the image sensor 1 to the optical interconnection unit 5 and transmits the signal generated in the image sensor 1 to the optical interconnection unit 5. The second electrical interconnection 9 electrically connects the optical interconnection unit 5 to the ISP 10 and transmits the signal transmitted through the optical interconnection unit 5 to the ISP 10. The third electrical interconnection 12 is electrically connected to the image sensor 1 and transmits signal for driving and controlling the image sensor 1. The fourth electrical interconnection 21 transmits the converted signal that is visually displayable in the ISP 10 to a display device, for example, a display module (e.g., see reference numeral 150 of FIG. 11A). The first through fourth electrical interconnections 2, 9, 12, and 21 may be formed of Cu or an alloy thereof.

The board 19 may include a rigid or flexible printed circuit board (PCB). The board 19 may include an electrical connection part 11 electrically coupled to the other board, for example, a board for displaying (e.g., see reference numeral 31 of FIG. 11A). The electrical connection part 11 may be disposed on an end of the board 19. The electrical connection part 11 may have an open structure in which the third and fourth electrical interconnections 12 and 21 are opened at the end of the board 19.

The image sensor 1 may include an image capturing device such as a charge coupled device (CCD) that obtains an image to generate an electrical signal or a complementary metal oxide semiconductor (CMOS).

The electrical signal generated in the image sensor 1 may be serialized in the order of R, G, and B or in a different order. The electrical signal generated in the image sensor 1 may include a video signal and a clock signal. The video signal and the clock signal may be separated from each other to transmit the separated video or clock signal to the optical interconnection unit 5 through the first electrical interconnection 2. The first electrical interconnection 2 may include a first video signal electrical interconnection 2a providing a transmission path of the video signal and a first clock signal electrical interconnection 2b providing a transmission path of the clock signal. The video signal and the clock signal may be a differential signal or a single-ended signal.

The optical interconnection unit 5 may include an optical waveguide 6, an optical transmitting part including a light source 4 disposed at one end of the optical waveguide 6 and a first semiconductor chip 3, and an optical receiving part including a light receiving device 7 disposed at the other end of the optical waveguide 6 and a second semiconductor chip 8. The light source 4 and the first semiconductor chip 3 may be disposed adjacent to the image sensor 1, and the light receiving device 7 and the second semiconductor chip 8 may be disposed adjacent to the ISP 10. The first semiconductor chip 3 may include a light source driver chip that drives the light source 4 to convert the electrical signal (i.e., the video signal and the clock signal) generated in the image sensor 1 into the optical signal. The second semiconductor chip 8 may include a light receiving device driver chip that drives the light receiving device 7 to restore the video signal and the clock signal converted into the optical signal to the electrical signal. The optical waveguide 6 may have a core-clad waveguide structure or a metal wire waveguide structure. At least one of the light source 4 and the light receiving device 7 may include a vertical cavity surface emitting laser (VCSEL), a PIN diode, or a photodiode.

The video signal and the clock signal generated in the image sensor 1 may be converted from the electrical signal into the optical signal in the light source 4 by driving the first semiconductor chip 3. The optical signal may be transmitted to the light receiving device 7 through the optical waveguide 6. In drawings, a dot line extending in a length direction of the optical waveguide 6 represents a transmission path of the optical signal, and it is similarly applicable to the following drawings. The second semiconductor chip 8 may drive the light receiving device 7 to restore the optical signal transmitted through the optical waveguide 6 to the electrical signal. The video signal and the clock signal restored to the electrical signal may be transmitted to the ISP 10 through the second electrical interconnection 9. The second electrical interconnection 9 may include a second video signal electrical interconnection 9a providing a transmission path of the video signal and a second clock signal electrical interconnection 9b providing a transmission path of the clock signal.

The video signal and the clock signal restored to the electrical signal and transmitted to the ISP 10 may be divided into a horizontal pixel and a vertical pixel and converted into an image that is visually recognizable on a liquid crystal display (for example, see reference numeral 34 of FIG. 11A). The signal converted through the ISP 10 may be transmitted to a display device, e.g., a display module (for example, see reference numeral 150 of FIG. 11A).

FIG. 2C is an enlarged perspective view illustrating a portion of FIG. 2A, FIG. 2D is a sectional view, and FIG. 2E is a perspective view of an optical waveguide.

Referring to FIG. 2C, the optical interconnection unit 5 may have a structure in which the light source 4 and light receiving device 7 are disposed on both ends of the optical waveguide 6. For convenience, although the first semiconductor chip 3 and the second semiconductor chip 8 are not illustrated, it will be apparently understood by those of ordinary skill in the art that the first semiconductor chip 3 is disposed adjacent to the light source 4, and the second semiconductor chip 8 is disposed adjacent to the light receiving device 7. The light source 4 may be spaced from or contact the optical waveguide 6. The optical waveguide 6 may provide the transmission path of the optical signal. The optical waveguide 6 may be flexible bent.

For example, the optical waveguide 6 may have a core-clad waveguide structure in which a clad 6b surrounds a core 6a. The core 6a may be formed of dielectric, and the clad 6b may be formed of an organic or inorganic polymer optical material or a polymer optical material (e.g., fluorinated poly arylene ether) including halogen elements or deuterium. In the core-clad waveguide structure, both the core 6a and the clad 6b may be formed of dielectric. The core 6a may be formed of dielectric having a relatively high refractive index (or permittivity) than that of the clad 6b. The waveguide 6 having the core-clad structure may include an optical fiber.

For another example, the optical waveguide 6 may have a metal wire waveguide structure in which a clad 6b formed of dielectric such as a polymer optical material including halogen elements or deuterium surrounds a core 6a formed of a metal such as gold or silver. The signal processing using an electrical interconnection formed of copper may have limitations such as electromagnetic interface (EMI) between adjacent signals, impedance mismatch, skew, crosstalk, electromagnetic compatibility (EMC), and transmission losses. Thus, when the existing electrical interconnection is replace with an optical interconnection unit, the above-described limitations may be solved, and simultaneously, data having high capacity may be transmitted at a high speed. The optical interconnection unit 5 of this embodiment may solve the above-described limitations of the existing electrical interconnection and realize high speed transmission of high capacity data.

Referring to FIG. 2D, the optical interconnection unit 5 may have a 45 degrees reflective mirror coupling structure in which an optical signal 20 is generated in a vertical direction and progress in a horizontal direction. For example, the light source 4 may include a first substrate 4a having a first trench 4c serving as a reflective mirror on a bottom surface thereof and a light emitting part 4b disposed on a top surface of the first substrate 4a to emit light. The optical signal 20 generated from the light emitting part 4b may vertically progress toward the bottom surface of the first substrate 4a, and the first trench 4c may change a transmission path of the optical signal 20 from a vertical direction to a horizontal direction. Thus, the optical signal 20 may be optically coupled to the core 6a and progress to the light receiving device 7. The light receiving device 7 may include a second substrate 7a having a second trench 7c serving as a reflective minor on a bottom surface thereof and a light receiving part 7b disposed on a top surface of the second substrate 7a to receive light. The optical signal 20 transmitted through the core 6a in the horizontal direction may be changed in transmission path from a horizontal direction to a vertical direction to reach the light receiving part 7b. The light emitting part 4b and the light receiving part 7b may include a vertical cavity surface emitting laser (VCSEL).

Referring to FIG. 2E, the core 6a may have an arbitrary sectional shape. For example, the core 6a may include a strip type metal wire or dielectric having a square sectional shape with a thickness T ranging from about 5 nm to about 200 nm and a width W ranging from about 2 μm to about 100 μm. Although two cores 6a that serve as the transmission paths of the video signal and the clock signal, respectively, are illustrated in the drawings, the inventive concept is not limited thereto. For example, when a large amount of data is transmitted through the core 6a, the number of cores 6a, i.e., the number of channels may increase.

Generally, a metal wire built in a dielectric may transmit incident light up to several centimeters. An optical waveguide using the metal wire is referred to as a metal wire waveguide. The metal wire waveguide may sufficiently transmit an optical signal using a metal wire having a fine size, for example, a thickness ranging from about 5 nm to about 200 nm and a width ranging from about 2 μm to about 100 μm.

The optical signal may be transmitted through polarization effects of free electrons contained in the metal wire and a coupling of the polarizations. The sequential coupling of the free electrons is referred to as surface plasmon polariton. Also, long distance transmission using the surface plasmon polariton is referred to as long range surface plasmon polariton (LRSPP). According to this embodiment, the optical waveguide 6 may have a metal wire waveguide structure in which the core 6a is formed of a metal to use the LRSPP.

The optical interconnection unit may be variously embodied in configuration without being limited to FIGS. 2C through 2E. FIGS. 2F through 2K show various examples of the optical interconnection unit.

FIG. 2F is a perspective view illustrating another example of the optical interconnection unit in the digital camera module according to the first embodiment of the inventive concept, and FIG. 2G is a section view of the optical interconnection unit.

Referring to FIGS. 2F and 2G, an optical interconnection unit 5a may have a 45 degrees reflective minor coupling structure equal or similar to that of the optical interconnection unit 5 shown in FIGS. 2C through 2E. For example, a light source 4 emitting light in a vertical direction and a light receiving device 7 receiving light in a vertical direction may be disposed on both ends of an optical waveguide 6. The light source 4 and the light receiving device 7 may be spaced from or contact each other. The light source 4 and the light receiving device 7 may have overturned structures, unlike those of the light source 4 and the light receiving device 7 shown in FIGS. 2C and 2D.

For example, the light source 4 may have a structure in which a first trench 4c is defined in a top surface of a first substrate 4a, and a light emitting part 4b is disposed on a bottom surface of the first substrate 4a. The light receiving device 7 may have a structure in which a second trench 7c is defined in a top surface of a second substrate 7a, and a light receiving part 7b is disposed on a bottom surface of the second substrate 7a. For example, the light emitting part 4b and the light receiving part 7b may include a VCSEL. The light emitting part 4b may emit an optical signal 20 in a direction perpendicular to a direction from the bottom surface of the first substrate 4a toward the top surface of the first substrate 4a, and the first trench 4c may change a path of the optical signal 20 from a vertical direction to a horizontal direction. Thus, the optical signal 20 may progress to the light receiving device 7 through a core 6a. The second trench 7c may change the path of the optical signal 20 transmitted in the horizontal direction into a direction perpendicular to a direction from the top surface of the second substrate 7a toward the bottom surface of the second substrate 7a. Thus, the optical signal 20 may be changed in transmission path from the horizontal direction to the vertical direction to reach the light receiving part 7b.

FIG. 2H is a perspective view illustrating still another example of the optical interconnection unit in the digital camera module according to the first embodiment of the inventive concept, and FIG. 2I is a sectional view of the optical interconnection unit.

Referring to FIGS. 2H and 2I, in an optical interconnection unit 5b, a light source 4 and a light receiving device 7 may be disposed on both ends of an optical waveguide 6. The light source 4 and the light receiving device 7 may spaced from or contact each other. The light source 4 and the light receiving device 7 may emit and receives light in a horizontal direction, unlike the light source 4 and the light receiving device 7 shown in FIGS. 2C and 2D. According to this embodiment, the optical interconnection unit 5b may have a butt coupling structure in which the light source 4 and the light receiving device 7 are spaced from the optical waveguide 6.

For example, the light source 4 may have a structure in which a light emitting part 4b is disposed on a first substrate 4a, and a first waveguide 4c opened toward the optical waveguide 6 is disposed on a lateral surface of the light emitting part 4b. The light receiving device 7 may have a structure in which a light receiving part 7b is disposed on a second substrate 7a, and a second waveguide 7c opened toward the optical waveguide 6 is disposed on a lateral surface of the light receiving part 7b. For example, the light emitting part 4b and the light receiving part 7b may include a PIN photodiode, a photodiode, or an avalanche photodiode (APD). An optical signal 20 generated from the light emitting part 4b may progress in a horizontal direction along the first waveguide 4c. The optical signal 20 may be coupled to a core 6a to progress to the light receiving device 7. The optical signal 20 transmitted in a horizontal direction along the second waveguide 7c may be received into the light receiving part 7b.

FIG. 2J is a perspective view illustrating further still another example of the optical interconnection unit in the digital camera module according to the first embodiment of the inventive concept.

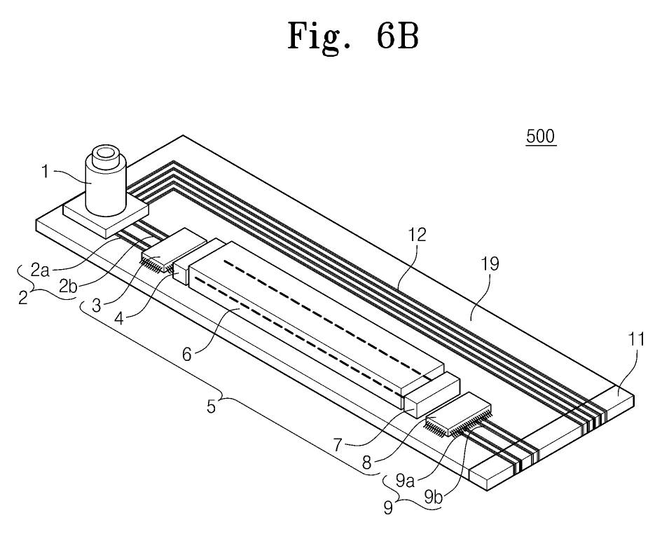

Referring to FIG. 2J, an optical interconnection unit 5c may further include an electrical interconnection 60. A light source 4 and a light receiving device 7 may have structures equal or similar to those of the light source 4 and the light receiving device 7 shown in FIGS. 2C through 2I. Although the electrical interconnection 60 is disposed on a top surface of an optical waveguide 6 in FIG. 6J, the inventive concept is not limited thereto. For example, the electrical interconnection 60 may be disposed on a bottom surface, a later surface, or the inside of the optical waveguide 6. The electrical interconnection 60 may provide a transmission path of an electrical signal that is not converted into an optical signal.

For example, referring to FIG. 2J together with FIG. 2A, the video signal and the clock signal generated in the image sensor 1 may be optically converted by the light source 4 to transmit the converted optical signal to the light receiving device 7 through the core 6a. An electrical signal (for example, an operation signal of the image sensor 1) that is not converted into the optical signal may be transmitted to the light receiving device 7 or the ISP 10 through the electrical interconnection 60. For another example, one of the video signal and the clock signal, e.g., the video signal may be separated from the clock signal to convert the video signal into an optical signal in the light source 4. The video signal converted into the optical signal may be transmitted to the light receiving device 7 through the core 6a, and the clock signal may be transmitted to the light receiving device 7 or the ISP 10 through the electrical interconnection 60.

The optical interconnection unit 5c further including the electrical interconnection 60 may be equally applicable to digital camera modules of various embodiments below as well as the digital camera module 100 of the first embodiment.

FIG. 2K is a sectional view illustrating still further another example of the optical interconnection unit in the digital camera module according to the first embodiment of the inventive concept.

Referring to FIG. 2K, an optical interconnection unit 5d may include a core 6c in which an electrical interconnection 60 and an optical interconnection 61 are combined with each other. A light source 4 and a light receiving device 7 may have structures equal to similar to those of the light source 4 and the light receiving device 7 shown in FIGS. 2C through 2I. The core 6c may have a structure in which the electrical interconnection 60 surrounds the optical interconnection 61 disposed at a central portion thereof. The core 6c may have an arbitrary sectional shape such as a circular shape, an oval shape, a square shape, or a polygon shape.

The optical interconnection 61 may include an optical fiber formed of dielectric having a relatively high refractive index or a metal wire formed of gold or silver to provide a transmission path of an optical signal. The electrical interconnection 60 may be formed of copper to provide a transmission path of an electrical signal. An insulator 62 may be disposed between the optical interconnection 61 and the electrical interconnection 62. The optical interconnection 61 may be formed of a material have a refractive index greater than that of the insulator 62. The core 6c may further include a second insulator 63 surrounding the electrical interconnection 60.

The optical interconnection unit 5d may including a core 6c in which the electrical interconnection 60 and the optical interconnection 61 are combined with each other may be equally applicable to digital camera modules of various embodiments below as well as the digital camera module 100 of the first embodiment.

The configuration of the optical interconnection unit may be variously embodied in addition to those of the optical interconnection unit shown in FIGS. 2C through 2k. The various examples will be described with reference to following embodiments.

### Second Embodiment

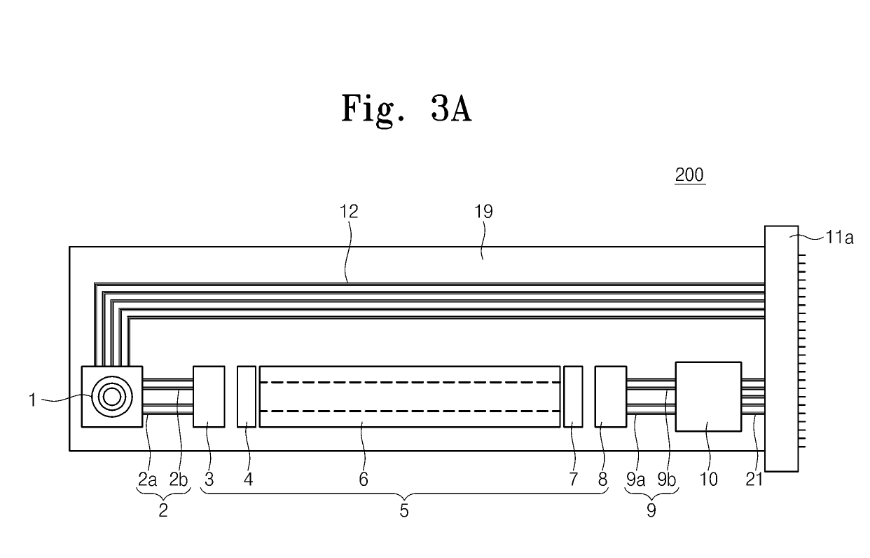

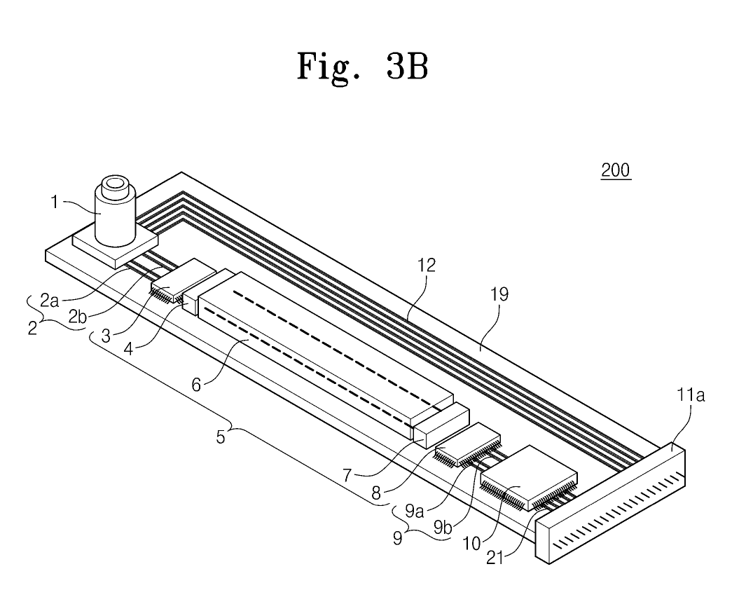

FIG. 3A is a plan view of a digital camera module according to a second embodiment of the inventive concept, and FIG. 3B is a perspective view of the digital camera module.

Referring to FIGS. 3A and 3B, a digital camera module 200 of the second embodiment may have a structure equal or similar to that of the first embodiment. That is, an image sensor 1, an optical interconnection unit 5, and an ISP 10 may be mounted on a board 19. Also, all video and clock signals may be optically converted to transmit the converted optical signal to the ISP 10 through an optical waveguide 6. First through fourth electrical interconnections 2, 9, 12, and 21 may be disposed on the board 19.

Differently from the first embodiment, the digital camera module 200 of the second embodiment may include an electrical connection part 11a having an electrical connector structure. When the board 19 is electrically connected to a different board, e.g., a board for displaying, a structure of the electrical connection part 11a may be easily modified according to a structure of an electrical connector disposed on the board for displaying. In addition, the structure described with reference to FIGS. 2A through 2K may be equally applicable to the digital camera module 200 of the second embodiment, and thus, their detail descriptions will be omitted.

### Third Embodiment

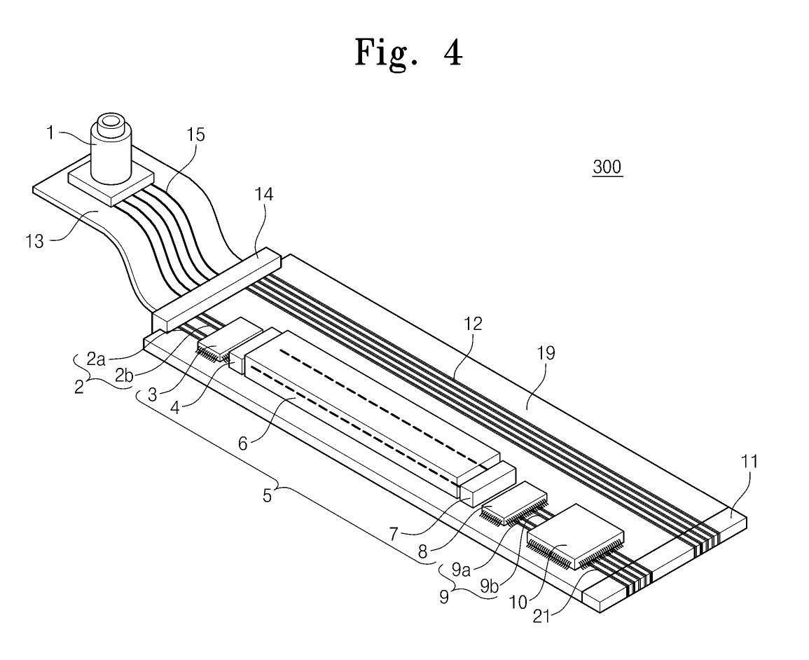

FIG. 4 is a perspective view of a digital camera module according to a third embodiment of the inventive concept.

Referring to FIG. 4, a digital camera module 300 of the third embodiment may have a structure equal or similar to that of the first embodiment. For example, the digital camera module 300 may include an image sensor 1, an optical interconnection unit 5, and an ISP 10. Also, all video and clock signals generated in the image sensor 1 may be optically converted to transmit the converted optical signal to the ISP 10 through an optical waveguide 6.

Differently from the first embodiment, the image sensor 1 may be mounted on a flexible board 13, and the optical interconnection unit 5 and the ISP 10 may be mounted on a board 19. The board 19 may have an end including an electrical connection part 11 having an open structure. The flexible board 13 may be electrically connected to the board 19 through an electrical connector 14. The flexible board 13 may include an electrical interconnection 15 which is electrically connected to first and third electrical interconnections 2 and 12.

In the digital camera module 300 of the third embodiment, since the image sensor 1 is separately mounted on the flexible board 13, the image sensor 1 may be freely mounted without reference to a mounting position of the board 19. Thus, when a digital camera is designed according to the third embodiment, the digital camera module 300 may be freely designed somewhat without any limitation in mounting position. In addition, the structure described with reference to FIGS. 2A through 2K may be equally applicable to the digital camera module 300 of the second embodiment.

### Fourth Embodiment

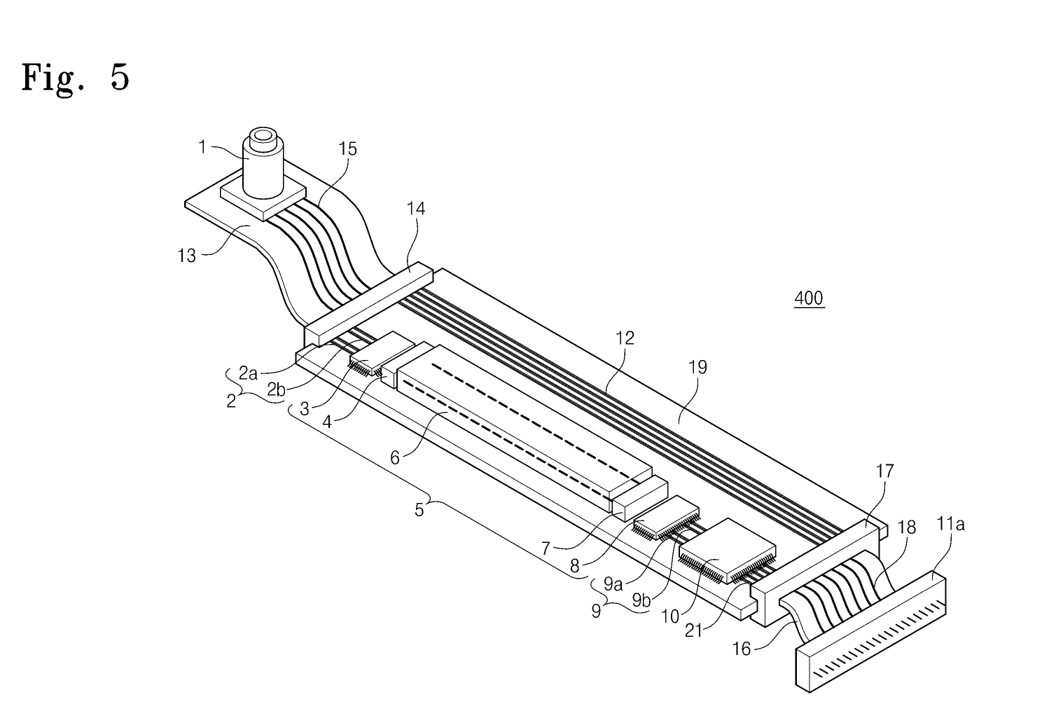

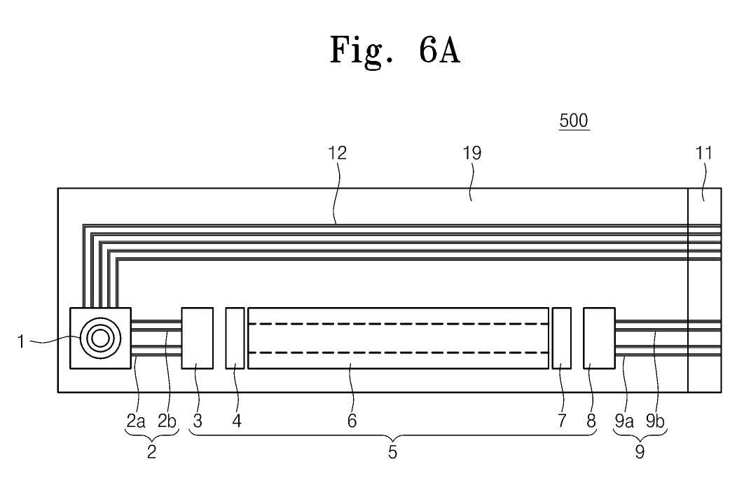

FIG. 5 is a perspective view of a digital camera module according to a fourth embodiment of the inventive concept.

Referring to FIG. 5, a digital camera module 400 of the fourth embodiment may have a structure equal or similar to that of the first embodiment. For example, the digital camera module 400 may include an image sensor 1, an optical interconnection unit 5, and an ISP 10. Also, all video and clock signals generated in the image sensor 1 may be optically converted to transmit the converted optical signal to the ISP 10 through an optical waveguide 6.

Differently from the first embodiment, the image sensor 1 may be mounted on a first flexible board 13, and the optical interconnection unit 5 and the ISP 10 may be mounted on a board 19. The first flexible board 13 may be electrically coupled to the board 19 through a first electrical connector 14. The first flexible board 13 may include an electrical interconnection 15 which is electrically connected to first and third electrical interconnections 2 and 12. In addition, the digital camera module 400 of the fourth embodiment may include an electrical connection part 11a having an electrical connector structure. The electrical connection part 11a may be mounted on a second flexible board 16 connected to the board 19 through a second electrical connector 17. The second flexible board 16 may include an electrical interconnection 18 which is electrically connected to third and fourth electrical interconnections 12 and 21.

In the digital camera module 400 of the fourth embodiment, since the image sensor 1 is separately mounted on the first flexible board 13, the image sensor 1 may be freely mounted without reference to a mounting position of the board 19. Also, since the electrical connection part 11a is separately mounted on the second flexible board 16, the electrical connection part 11a may be freely mounted without reference to the mounting position of the board 19. Thus, when a digital camera is designed according to the fourth embodiment, the digital camera module 400 may be freely designed somewhat without any limitation in mounting position. In addition, the structure described with reference to FIGS. 2A through 2K may be equally applicable to the digital camera module 400 of the fourth embodiment.

### Fifth Embodiment

FIG. 6A is a plan view of a digital camera module according to a fifth embodiment of the inventive concept, and FIG. 6B is a perspective view of the digital camera module.

Referring to FIGS. 6A and 6B, a digital camera module 500 of the fifth embodiment may have a structure similar to that of the first embodiment. For example, an image sensor 1 and an optical interconnection unit 5 may be mounted on a board 19. Also, all video and clock signals may be optically converted to transmit the converted optical signal through an optical waveguide 6. The board 19 may include an electrical connection part 11 having on open structure. The electrical connection part 11 may have an electrical connector structure, like the second embodiment.

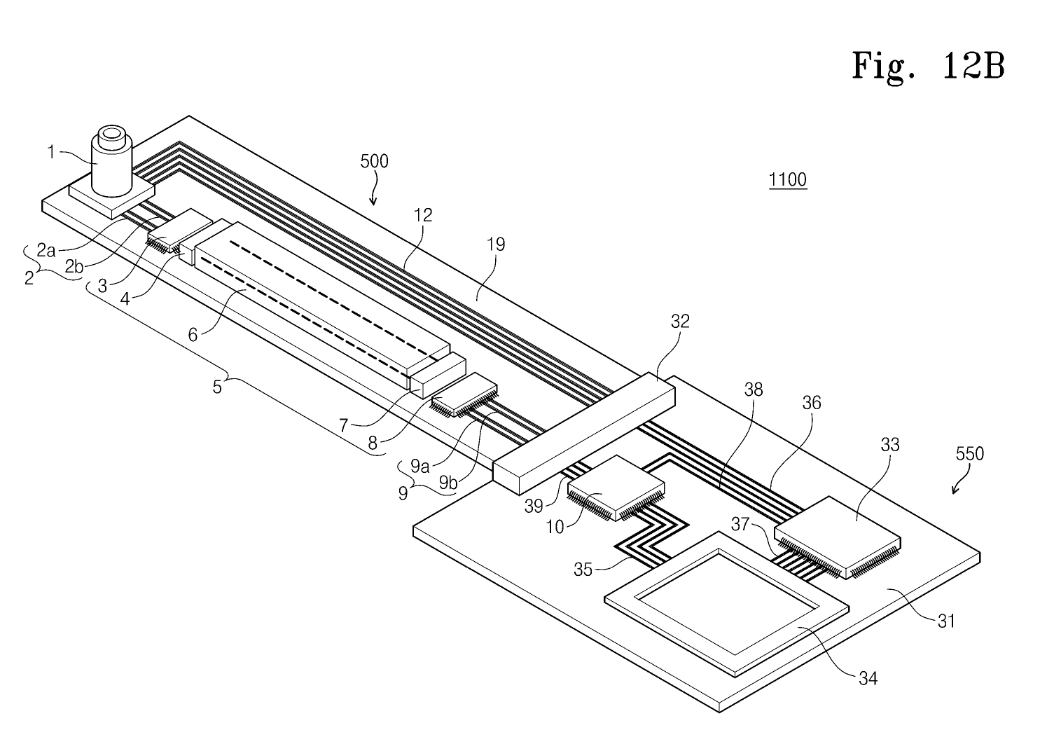

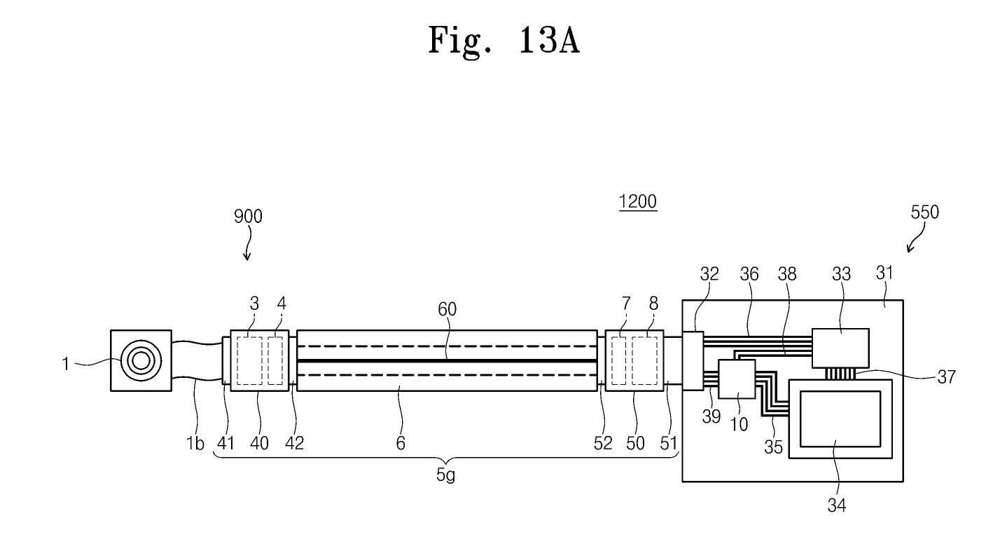

Differently from the first embodiment, the digital camera module 500 of the fifth embodiment may not include an ISP. Thus, an electrical interconnection for providing a path through which a signal converted in the ISP is transmitted, i.e., the fourth electrical interconnection 21 of FIG. 2A may not be provided on the board 19. For example, the ISP may be mounted on a different board (e.g., see reference numeral 31 of FIG. 12A) or integrally designed with a different chip (e.g., see reference numeral 33 of FIG. 12A). The video signal and the clock signal converted from an electrical signal to an optical signal by a first semiconductor chip 3 to transmit the converted optical signal through the optical waveguide 6 may be restored from the optical signal to the electrical signal by a second semiconductor chip 8. The video signal and the clock signal restored to the electrical signal may be transmitted to the ISP or a device (e.g., see reference numeral 550 of FIG. 12A) including a chip with which the ISP is combined through the electrical connection part 11.

The digital camera module 500 of the fifth embodiment may have a structure in which the image sensor 1 is mounted on a flexible board, like the third embodiment or a structure in which the image sensor 1 and the electrical connection part 11 are mounted on different flexible boards, respectively, like the fourth embodiment. In addition, the structure described with reference to FIGS. 2A through 2K may be equally applicable to the digital camera module 500 of the fifth embodiment.

### Sixth Embodiment

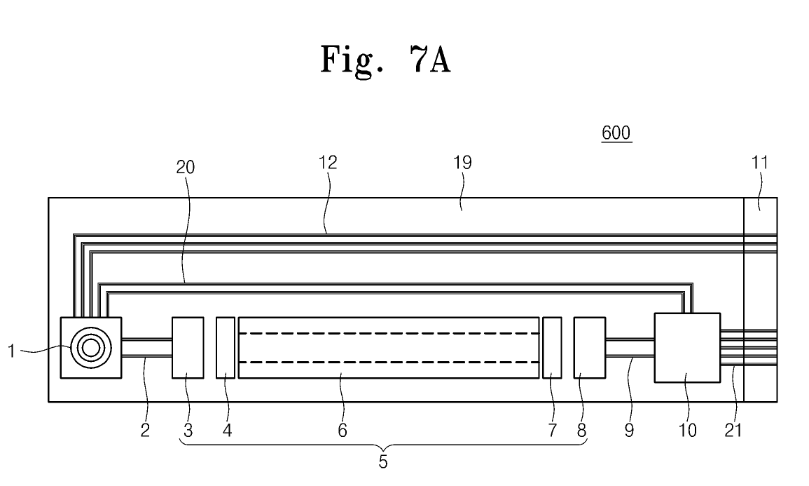

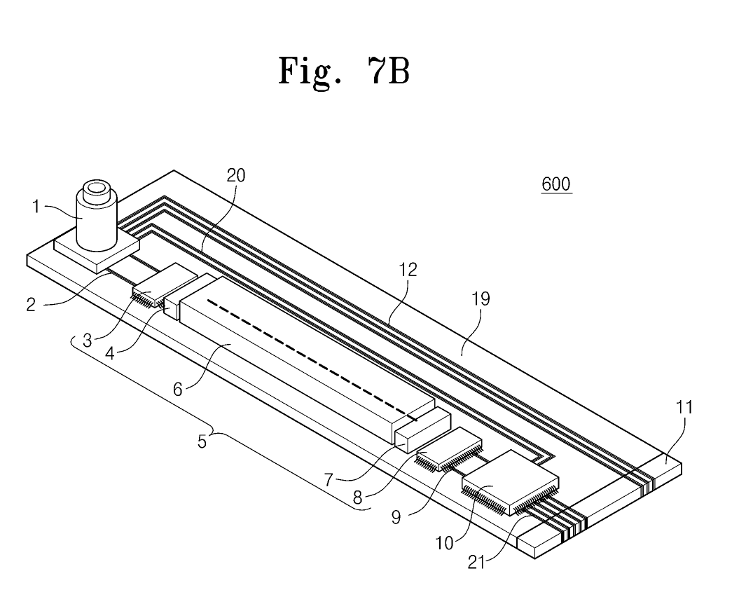

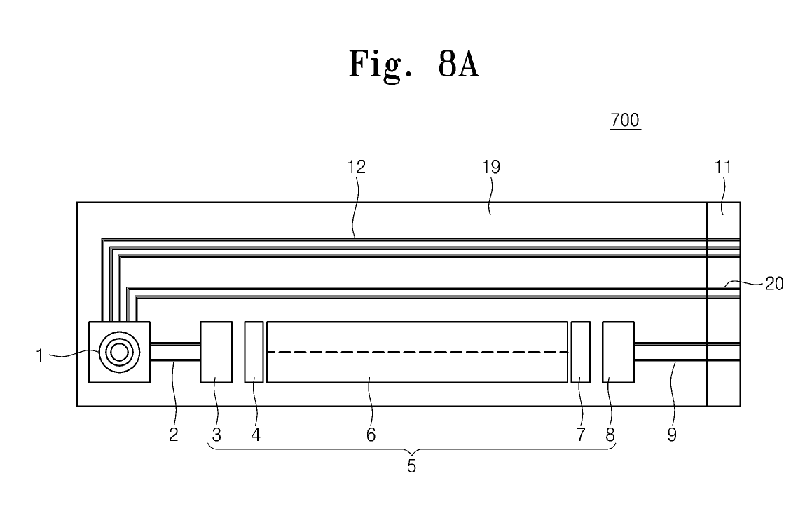

FIG. 7A is a plan view of a digital camera module according to a sixth embodiment of the inventive concept, and FIG. 7B is a perspective view of the digital camera module.

Referring to FIGS. 7A and 7B, a digital camera module 600 of the sixth embodiment may have a structure similar to that of the first embodiment. For example, an image sensor 1, an optical interconnection unit 5, and an ISP 10 may be mounted on a board 19. Also, an electrical signal generated in the image sensor 1 may be converted into an optical signal to transmit the converted optical signal to the ISP 10 through an optical waveguide 6. The board 19 may include an electrical connection part 11 having an open structure. For another example, the electrical connection part 11 may have an electrical connector structure, like the second embodiment.

Unlike the first embodiment, the digital camera module 600 of the sixth embodiment may have a structure in which one of a video signal and a clock signal generated the image sensor 1 is transmitted through the optical waveguide 6. The video signal and the clock signal generated in the image sensor 1 may have different amounts of data. For example, the video signal may have a relatively large amount of data when compared to that of the clock signal. Thus, the video signal having a relatively large amount of data may be converted from an electrical signal to an optical signal to transmit the converted optical signal through the optical waveguide 6. According to the sixth embodiment, a first electrical interconnection 2 may be provided as a path for transmitting the video signal generated in the image sensor 1 to the optical interconnection unit 5, and a second electrical interconnection 9 may be provided as a path for transmitting the video signal transmitted through the optical interconnection unit 5 to the ISP 10.

The digital camera module 600 of the sixth embodiment may further include a fifth electrical interconnection 20 for providing a transmission path of the clock signal. The fifth electrical interconnection 20 may be disposed between the image sensor 1 and the ISP 10. Thus, the clock signal generated in the image sensor 1 may not be converted into the optical signal and may be transmitted to the ISP 10 through the fifth electrical interconnection 20.

The digital camera module 600 of the sixth embodiment may have a structure in which the image sensor 1 is mounted on a flexible board, like the third embodiment or a structure in which the image sensor 1 and the electrical connection part 11 are mounted on different flexible boards, respectively, like the fourth embodiment. In addition, the structure described with reference to FIGS. 2A through 2K may be equally applicable to the digital camera module 600 of the sixth embodiment.

### Seventh Embodiment

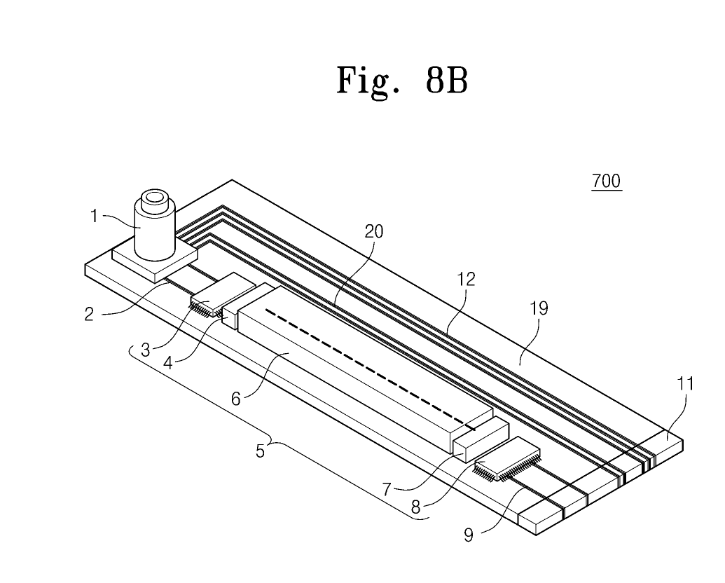

FIG. 8A is a plan view of a digital camera module according to a seventh embodiment of the inventive concept, and FIG. 8B is a perspective view of the digital camera module.

Referring to FIGS. 8A and 8B, a digital camera module 700 of the seventh embodiment may have a structure similar to that of the first embodiment. For example, an image sensor 1 and an optical interconnection unit 5 may be mounted on a board 19. Also, a signal generated in the image sensor 1 may be optically converted to transmit the converted optical signal through an optical waveguide 6. The board 19 may include an electrical connection part 11 having an open structure. For another example, the electrical connection part 11 may have an electrical connector structure, like the second embodiment.

Unlike the first embodiment, the digital camera module 700 of the seventh embodiment may not include an ISP. For example, the ISP may be mounted on a different board or integrally designed with a different chip mounted on a different board. Also, unlike the first embodiment, the digital camera module 700 of the seventh embodiment may further include a fifth electrical interconnection 20 for transmitting a clock signal (having a relatively small amount of data) of a video and clock signals which are generated in the image sensor 1. Unlike the sixth embodiment, the fifth electrical interconnection 20 may be disposed between the image sensor 1 and the electrical connection part 11.

A first electrical interconnection 2 may be provided as a path for transmitting the video signal (having a relatively large amount of data) of the video and clock signals generated in the image sensor 1. A second electrical interconnection 9 may be provided as a path for transmitting the video signal transmitted through the optical interconnection unit 5 to the ISP 10.

The digital camera module 700 of the seventh embodiment may have a structure in which the image sensor 1 is mounted on a flexible board, like the third embodiment, or a structure in which the image sensor 1 and the electrical connection part 11 are mounted on different flexible boards, respectively, like the fourth embodiment. In addition, the structure described with reference to FIGS. 2A through 2K may be equally applicable to the digital camera module 700 of the seventh embodiment.

### Eighth Embodiment

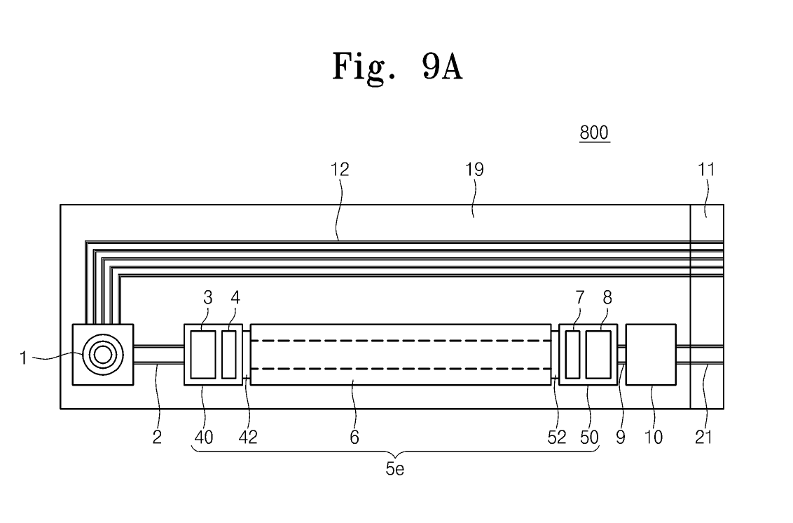

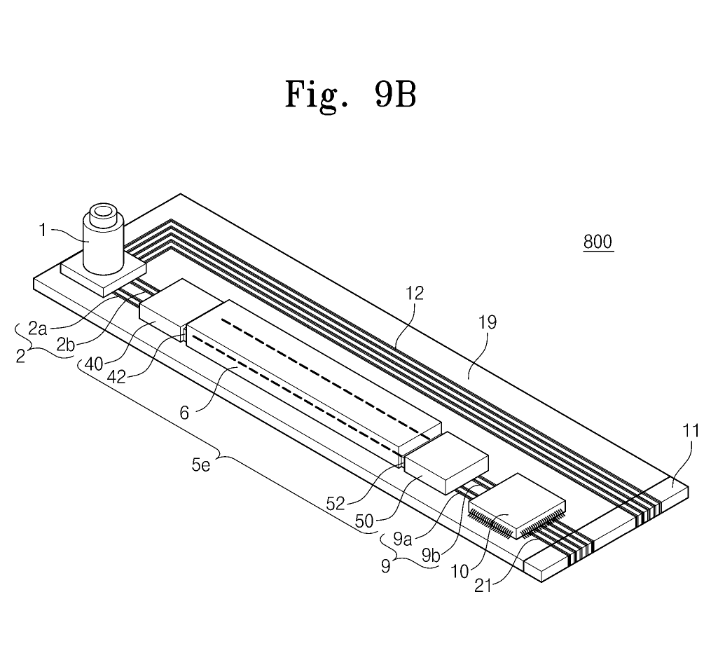

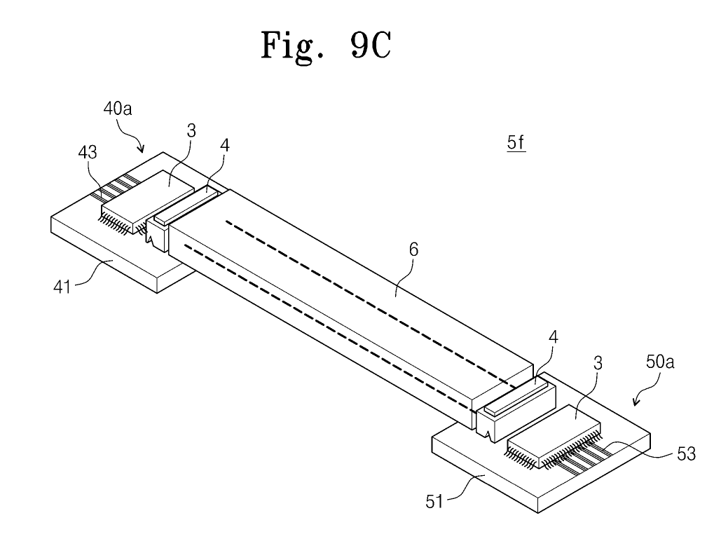

FIG. 9A is a plan view of a digital camera module according to an eighth embodiment of the inventive concept, and FIG. 9B is a perspective view of the digital camera module. FIG. 9C is a perspective view illustrating another example of an optical interconnection unit in the digital camera module according to the eighth embodiment of the inventive concept.

Referring to FIGS. 9A and 9B, a digital camera module 800 of the eighth embodiment may have a structure similar to that of the first embodiment. For example, an image sensor 1, an optical interconnection unit 5, and an ISP 10 may be mounted on a board 19. Also, an electrical signal generated in the image sensor 1 may be converted into an optical signal to transmit the converted optical signal to the

ISP 10 through an optical waveguide 6. The board 19 may include an electrical connection part 11 having an open structure. For another example, the electrical connection part 11 may have an electrical connector structure, like the second embodiment.

Unlike the first embodiment, the digital camera module 800 of the eighth embodiment may include a module type optical interconnection unit 5e. For example, the optical waveguide 6 may have one end at which an optical transmitting module 40 is separably coupled to the optical waveguide 6 through an optical transmitting connector 42 and the other end at which an optical receiving module 50 is separably coupled to the optical waveguide 6 through an optical receiving connector 52. The optical transmitting module 40 may include a light source 4 and a first semiconductor chip 3, and the optical receiving module 50 may include a light receiving device 7 and a second semiconductor chip 8.

The optical transmitting connector 42 may be provided in the optical transmitting module 40 or the optical waveguide 6. Alternatively, the optical transmitting connector 42 may be coupled to connectors respectively provided in the optical transmitting module 40 and the optical waveguide 6. Similarly, the optical receiving connector 52 may be provided in the optical receiving module 50 or the optical waveguide 6. Alternatively, the optical receiving connector 52 may be coupled to connectors respectively provided in the optical receiving module 50 and the optical waveguide 6.

According to this embodiment, the optical transmitting module 40 and the optical receiving module 50 may be easily separated from the optical waveguide 6 to replace the optical transmitting module 40 and the optical receiving module 50. Also, the optical waveguide 6 may be easily separated from the optical transmitting module 40 and the optical receiving module 50 to replace the optical waveguide 6. The module type optical interconnection unit 5e may be replaced with another module type optical interconnection unit 5f illustrated in FIG. 9C below.

Referring to FIG. 9C together with FIG. 9A, a module type optical interconnection unit 5f may have a structure in which an optical waveguide 6 has one end at which an optical transmitting module 40a is separably coupled to the optical waveguide 6 through an optical transmitting board 41 and the other end at which an optical receiving module 50a is separably coupled to the optical waveguide 6 through an optical receiving board 51. For example, the optical transmitting module 40a may include the optical transmitting board 41 on which a first semiconductor chip 3 and a light source 4 are mounted. An electrical connection part 43 having an open structure and electrically connected to a first electrical interconnection 2 may be disposed on the optical transmitting board 41. The optical receiving module 50a may include the optical receiving board 51 on which a light receiving device 7 and a second semiconductor chip 8 are mounted. An electrical connection part 53 having an open structure and electrically connected to a second electrical interconnection 9 may be disposed on the optical receiving board 51. The optical waveguide 6 may have one end mounted on the optical transmitting board 41 and coupled to the light source 4. Similarly, the optical waveguide 6 may have the other end mounted on the optical receiving board 51 and coupled to the light receiving device 7.

The digital camera module 800 of the eighth embodiment may have a structure in which the image sensor 1 is mounted on a flexible board, like the third embodiment, or a structure in which the image sensor 1 and the electrical connection part 11 are mounted on different flexible boards, respectively, like the fourth embodiment. In addition, the structure described with reference to FIGS. 2A through 2K may be equally applicable to the digital camera module 800 of the eighth embodiment. The module type optical interconnection unit 5e or the modified module type optical interconnection unit 5f may be applicable to all embodiments disclosed in the inventive concept as well as the eighth embodiment.

### Ninth Embodiment

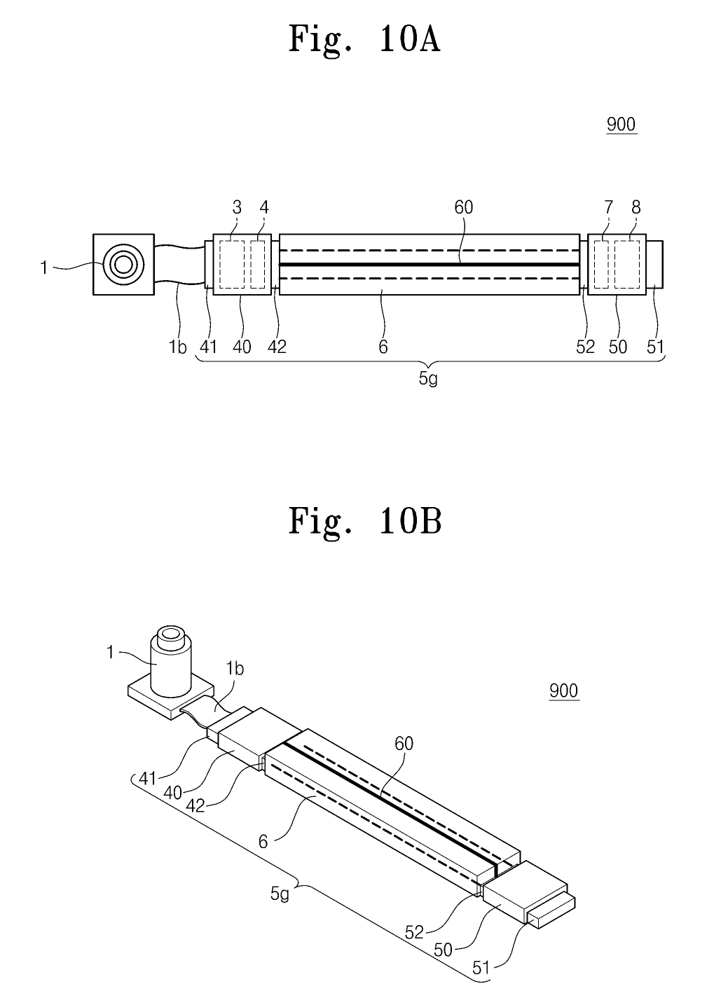

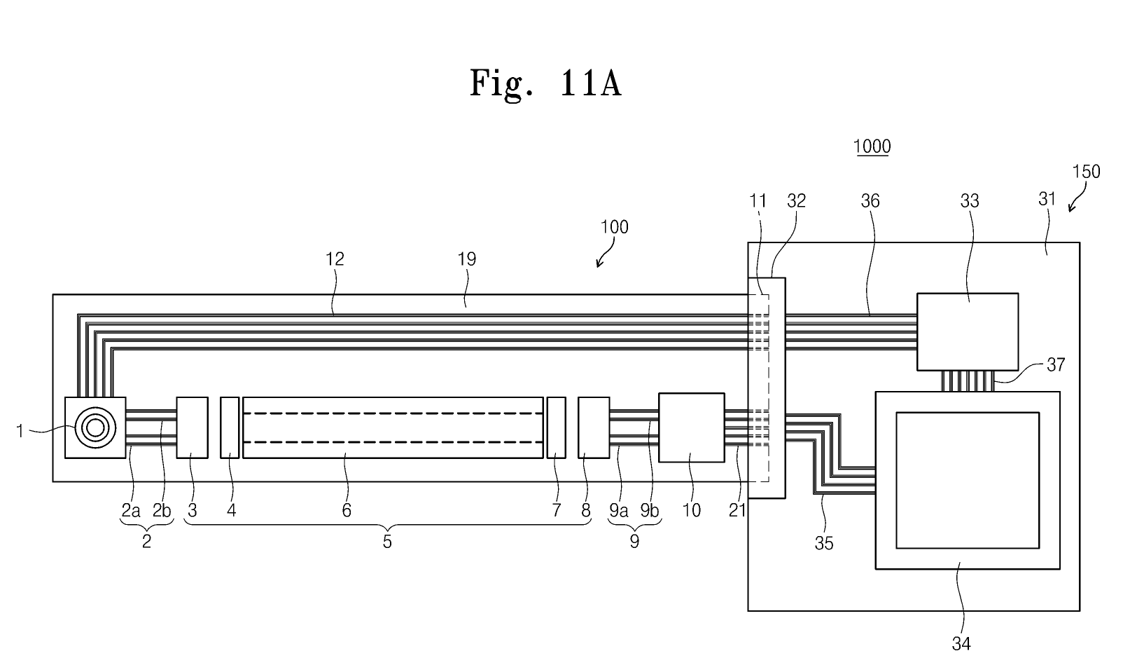

FIG. 10A is a plan view of a digital camera module according to a ninth embodiment of the inventive concept, and FIG. 10B is a perspective view of the digital camera module.

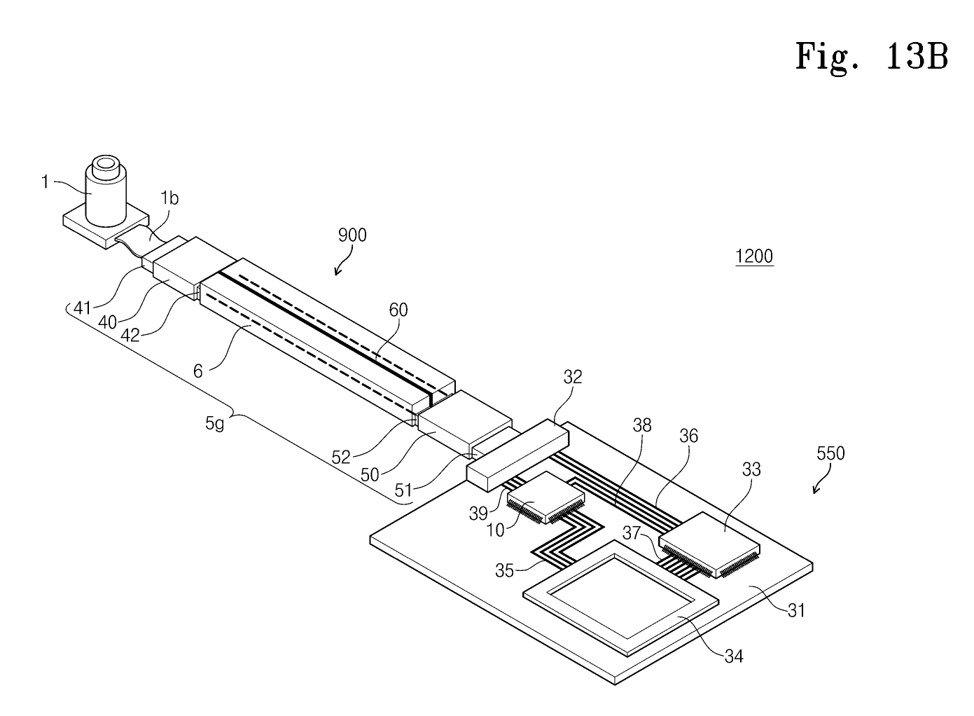

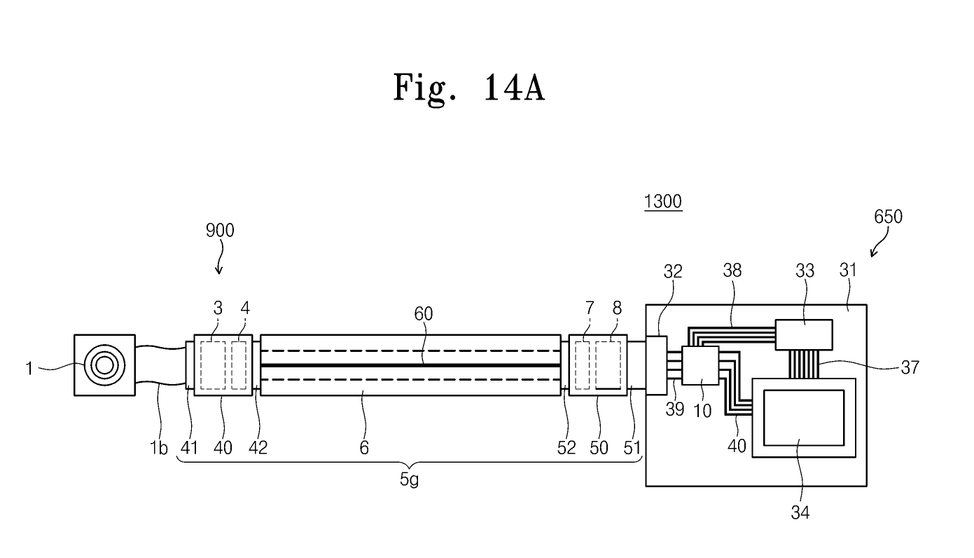

Referring to FIGS. 10A and 10B, a digital camera module 900 of the ninth embodiment may have a module type structure. For example, the digital camera module 900 may include a module type optical interconnection unit 5g and an image sensor 1 electrically connected to an end of the module type optical interconnection unit 5g. The digital camera module 900 may not include a board on which the optical interconnection unit 5g and the image sensor 1 are mounted. The digital camera module 900 may not include an ISP. For example, the ISP may be mounted on a display board (e.g., see reference numeral 31 of FIG. 13A).

In the module type optical interconnection unit 5g, an optical waveguide 6 may have one end at which an optical transmitting module 40 is separably coupled to the optical waveguide 6 through an optical transmitting connector 42 and the other end at which an optical receiving module 50 is separably coupled to the optical waveguide 6 through an optical receiving connector 52. The optical transmitting module 40 may include a light source 4 and a first semiconductor chip 3, and the optical receiving module 50 may include a light receiving device 7 and a second semiconductor chip 8. According to this embodiment, the optical transmitting module 40 and the optical receiving module 50 may be easily separated from the optical waveguide 6 to replace the optical transmitting module 40 and the optical receiving module 50. Also, the optical waveguide 6 may be easily separated from the optical transmitting module 40 and the optical receiving module 50 to replace the optical waveguide 6.

The optical transmitting connector 42 may be provided in the optical transmitting module 40 or the optical waveguide 6. Alternatively, the optical transmitting connector 42 may be coupled to connectors respectively provided in the optical transmitting module 40 and the optical waveguide 6. Similarly, the optical receiving connector 52 may be provided in the optical receiving module 50 or the optical waveguide 6. Alternatively, the optical receiving connector 52 may be coupled to connectors respectively provided in the optical receiving module 50 and the optical waveguide 6.

An electrical connector 41 may be further disposed on the optical transmitting module 40. The optical transmitting module 40 may be electrically connected to the image sensor 1 through the electrical connector 41. The image sensor 1 may further include a flexible electrical interconnection 1b electrically connected to the electrical connector 41. Thus, the image sensor 1 may be freely disposed without reference to the mounting position of the optical interconnection unit 5g. An electrical connector 51 electrically connected to a different board (e.g., see reference numeral 31 of FIG. 13A) may be further disposed on the optical receiving module 50.

The digital camera module 900 may not include the board on which the optical interconnection unit 5g and the image sensor 1 are mounted. Thus, at least one electrical interconnection 60 for providing a transmission path of an electrical signal needed to operate the image sensor 1 may be disposed on the optical waveguide 6. The electrical interconnection 60 may be disposed on an outer surface of the optical waveguide 6 or disposed inside the optical waveguide 6, equal or similar to that of FIG. 2J. Alternatively, the electrical interconnection 60 may be integrally designed with a core of the optical waveguide, equal or similar to that of FIG. 2K.

According to the ninth embodiment, since the board is not required and the module type optical interconnection unit 5g is provided, the optical transmitting module 40 and the optical receiving module 50 may be easily replaced. Also, since the electrical interconnections are integrally designed with the optical waveguide 6, the digital camera module 900 may be reduced in size. In addition, this embodiment may be contributed for miniaturization of a product (e.g., a mobile phone or a compact digital camera) using the digital camera module 900. In addition, the structure described with reference to FIGS. 2A through 2K may be equally applicable to the digital camera module 700 of the seventh embodiment.

### Tenth Embodiment

FIG. 11A is a plan view of a digital camera module according to a tenth embodiment of the inventive concept, and FIG. 11B is a perspective view of the digital camera module.

Referring to FIGS. 11A and 11B, a digital camera module 1000 of the tenth embodiment may further include a display module 150 electrically connected to the digital camera module 100 of the first embodiment. In the tenth embodiment, an ISP 10 may be provided in the digital camera module 100, but the display module 150.

The display module 150 may include a display board 31 including a display electrical connector 32 electrically coupled to an electrical connection part 11 of the digital camera module 100. A display 34 that visually displays a signal transmitted from the digital camera module 100 and a third semiconductor chip 33 that controls an image sensor 1 and the display 34 may be mounted on the display board 31. The display board 31 may include a printed circuit board (PCB). The display 34 may include a liquid crystal display (LCD) monitor. The third semiconductor chip 33 may control the image sensor 1 and the display 34. In addition, the third semiconductor chip 33 may further include a plurality of chips for controlling an overall operation of the display module 150. The display board 31 may include a sixth electrical interconnection 35, a seventh electrical interconnection 36, and an eighth electrical interconnection 37. The sixth electrical interconnection 35 electrically connects the display electrical connector 32 to the display 34. The seventh electrical interconnection 36 electrically connects the display electrical connector 32 to the third semiconductor chip 33. The eighth electrical interconnection 37 electrically connects the third semiconductor chip 33 to the display 34. The sixth electrical interconnection 35 may be mainly used as a transmission path of a signal transmitted from the ISP 10. The seventh electrical interconnection 36 may be mainly used as a transmission path of an electrical signal needed to operate the image sensor 1. The eighth electrical interconnection 37 may be mainly used as a transmission path of an electrical signal needed to operate the display 34.

In the tenth embodiment, since the display module 150 may not include the ISP 10, the digital camera module 100 of the first embodiment may be replaced with a digital camera module including the ISP 10. For example, the digital camera module 100 of the first embodiment may be replaced with one of the digital camera modules 200, 300, and 400 of the second through fourth embodiments, the digital camera module 600 of the sixth embodiment, and the digital camera module 800 of the eighth embodiment.

### Eleventh Embodiment

FIG. 12A is a plan view of a digital camera module according to an eleventh embodiment of the inventive concept, and FIG. 12B is a perspective view of the digital camera module.

Referring to FIGS. 12A and 12B, a digital camera module 1100 of the eleventh embodiment may further include a display module 550 electrically connected to the digital camera module 500 of the fifth embodiment. In the eleventh embodiment, an ISP 10 may be provided in the display module 550, but the digital camera module 500.

The display module 550 may include a display board 31 including a display electrical connector 32 electrically coupled to an electrical connection part 11 of the digital camera module 500. An ISP 10 that converts a signal transmitted from the digital camera module 500 into a signal that is visually displayable, a display 34 that visually displays a signal transmitted from the ISP 10 and a third semiconductor chip 33 that controls an image sensor 1 and the display 34 and controls an overall operation of the display module 550 may be mounted on the display board 31. The display board 31 may include a PCB. The display 34 may include an LCD monitor. The third semiconductor chip 33 may include a plurality of chips combined as necessary. Sixth through eighth electrical interconnections 35, 36, and 37 may be disposed on the display board 31, equal or similar to that of the ninth embodiment. In addition, a ninth electrical interconnection 38 and a tenth electrical interconnection 39 may be further disposed on the display board 31. The ninth electrical interconnection 38 electrically connects the ISP 10 to the third semiconductor chip 33. The tenth electrical interconnection 39 electrically connects the display electrical connector 32 to the ISP 10. Unlike the tenth embodiment, the sixth electrical interconnection 35 may be disposed between the ISP 10 and the display 34.

In the tenth embodiment, since the display module 550 may include the ISP 10, the digital camera module 500 of the fifth embodiment may be replaced with a digital camera module in which the ISP 10 is not provided. For example, the digital camera module 500 of the fifth embodiment may be replaced with the digital camera module 700 of the seventh embodiment. For another example, the ISP 10 may be integrally designed with the third semiconductor chip 33. In this case, since the ISP 10 is not separately mounted on the display module 550, the display module 550 may be reduced in size.

### Twelfth Embodiment

FIG. 13A is a plan view of a digital camera module according to a twelfth embodiment of the inventive concept, and FIG. 13B is a perspective view of the digital camera module.

Referring to FIGS. 13A and 13B, a digital camera module 1200 of the twelfth embodiment may further include a display module 550 electrically connected to the digital camera module 900 of the ninth embodiment. In the twelfth embodiment, an ISP 10 may be provided in the display module 550. The digital camera module described with reference to FIGS. 10A and 10B may be equally applicable to the digital camera module 900 of the ninth embodiment. Also, the display module described with reference to FIGS. 12A and 12B may be equally applicable to the display module 500.

For example, since an electrical connector 51 disposed in an optical receiving module 50 is electrically coupled to a display electrical connector 32, the digital camera module 900 may be electrically connected to a display board 31. For another example, the electrical connector 51 may be electrically coupled to the display electrical connector 32 using an electrical medium therebetween, for example, a medium equal or similar to the flexible electrical interconnection 1b.

### Thirteenth Embodiment

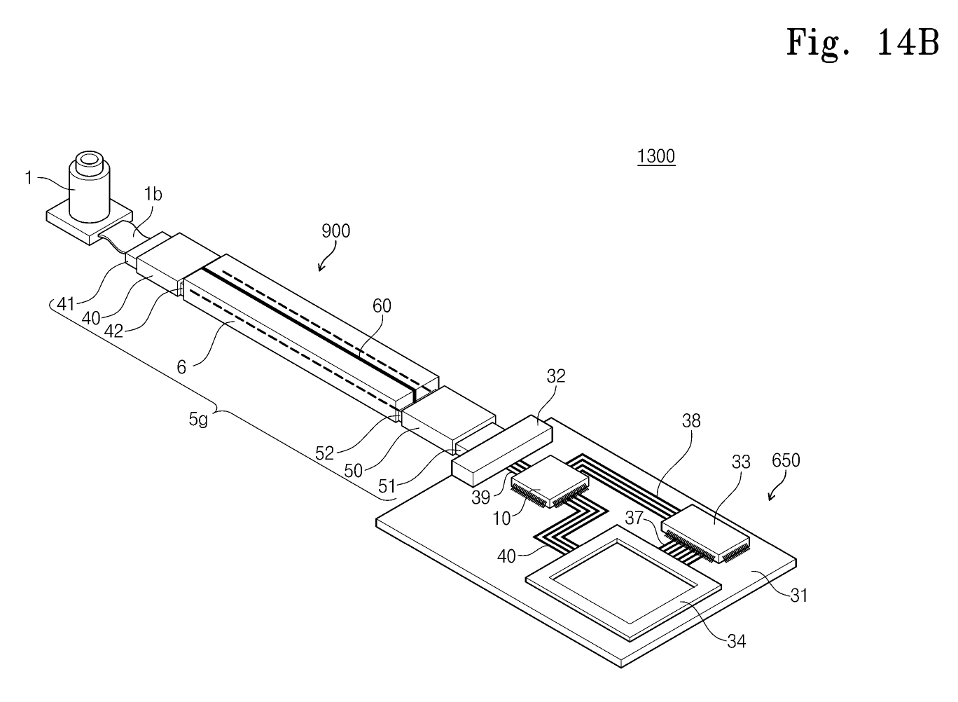

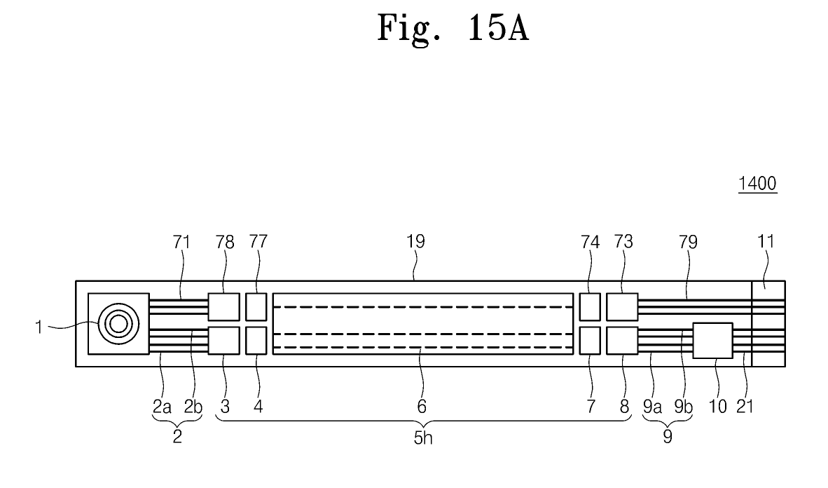

FIG. 14A is a plan view of a digital camera module according to a thirteenth embodiment of the inventive concept, and FIG. 14B is a perspective view of the digital camera module.

Referring to FIGS. 14A and 14B, a digital camera module 1300 of the thirteenth embodiment may further include a display module 650 electrically connected to the digital camera module 900 of the ninth embodiment. The digital camera module described with reference to FIGS. 10A and 10B may be equally applicable to the digital camera module 900. Also, the display module described with reference to FIGS. 12A and 12B may be equally applicable to the display module 650.

Unlike the display module 550 of the twelfth embodiment, the display module 650 of this embodiment may not include a seventh electrical interconnection (See reference numeral 36 of FIG. 13A) mainly used as a transmission path of an electrical signal needed to operate an image sensor 1. In this case, the electrical signals needed to operate the image sensor 1 may be transmitted to an optical interconnection unit 5g through a ninth electrical interconnection 38, an ISP 10, and a tenth electrical interconnection 39. The electrical signals transmitted to the optical interconnection unit 5g may transmitted to the image sensor 1 through an electrical interconnection 60 of an optical waveguide 6 to control the image sensor 1. According to this embodiment, since the display module 650 does not include the seventh electrical interconnection, the display module 650 may be reduced in size.

### Fourteenth Embodiment

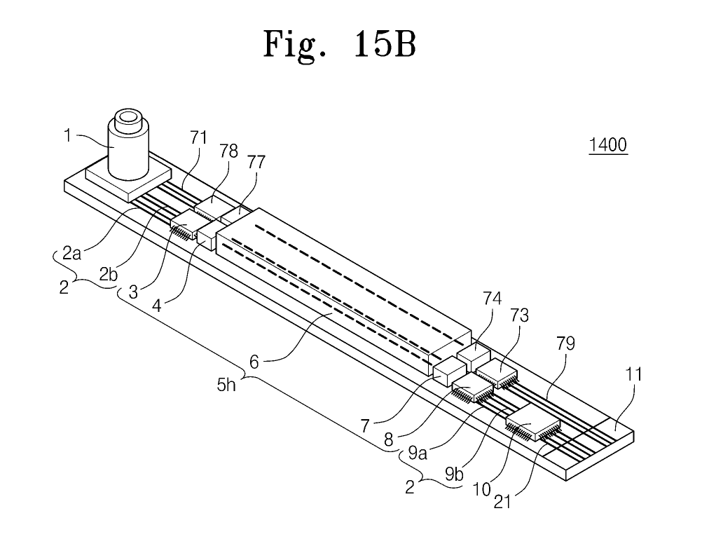

FIG. 15A is a plan view of a digital camera module according to a fourteenth embodiment of the inventive concept, and FIG. 15B is a perspective view of the digital camera module.

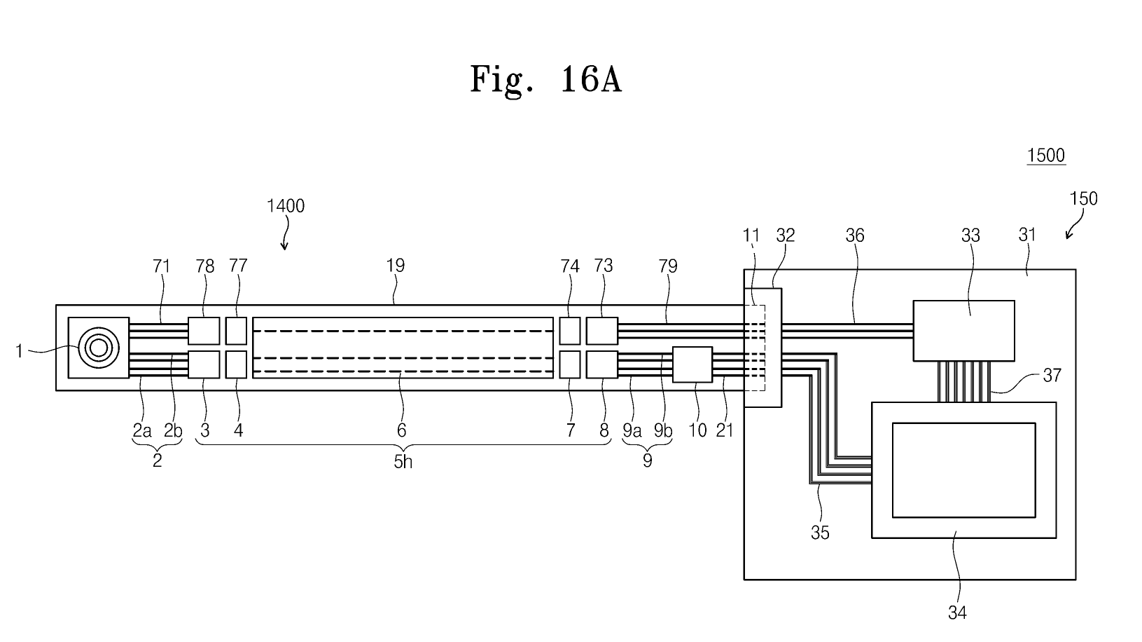

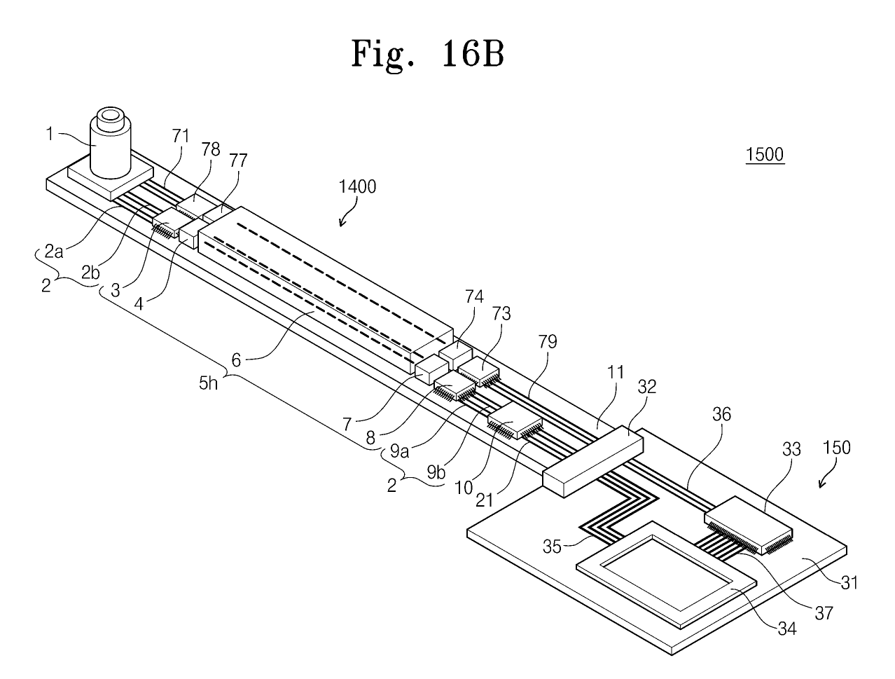

Referring to FIGS. 15A and 15B, a digital camera module 1400 of the fourteenth embodiment may include a board 19 on which an image sensor 1, an optical interconnection unit 5h, and an ISP 10 are mounted, similar to that of the first embodiment. On the other hand, the digital camera module 1400 may not include the ISP 10. In this case, the ISP 10 may be integrally designed with a different board (e.g., see reference numeral 31 of FIG. 16A) or a different chip (e.g., see reference numeral 33 of FIG. 16A).

Unlike the previously described embodiments, the optical interconnection unit 5h may be designed to enable bidirectional communication. According to this embodiment, the optical interconnection unit 5h may include an optical waveguide 6, first optical transmitting parts 3 and 4 and second optical receiving parts 77 and 78 that are disposed at one end of the optical waveguide 6 adjacent to the image sensor 1, and first optical receiving parts 7 and 8 and second optical transmitting parts 73 and 74 that are disposed at the other end of the optical waveguide 6 adjacent to the ISP 10. A video signal and clock signal generated in the image sensor 1 may be converted from an electrical signal to an optical signal in the first optical transmitting parts 3 and 4 to transmit the converted optical signal through the optical waveguide 6. An electrical signal needed to operate the image sensor 1 may be converted into the optical signal in the second optical transmitting parts 73 and 74 to transmit the converted optical signal through the optical waveguide 6.

The first optical transmitting parts 3 and 4 may include a first semiconductor chip 3 (hereinafter, referred to as a first light source driver chip) that converts the video and clock signals generated in the image sensor 1 from the electrical signal to the optical signal and a light source 4 (hereafter, referred to as a first light source). The first optical receiving parts 7 and 8 may include a light receiving device 7 (hereinafter, referred to as a first light receiving device) that restores the video and clock signals converted into the optical signal to the electrical signal and a second semiconductor chip 8 (hereinafter, referred to as a first light receiving device driver chip). The second optical transmitting parts 73 and 74 may include a second light source driver chip 73 that converts an electrical signal needed to operate the image sensor 1 into a optical signal and a second light source 74. The second optical receiving parts 77 and 78 may include a second light receiving device 77 that restores an operation signal of the image sensor 1 converted into the optical signal to the electrical signal and a second light receiving device driver chip 78.

The second optical transmitting parts 73 and 74 may have a structure equal or similar to that of the first optical transmitting parts 3 and 4, for example, a 45 degrees reflective minor coupling structure as illustrated in FIG. 2C or 2F or a butt coupling structure as illustrated in FIG. 2H. Similarly, the second optical receiving parts 77 and 78 may have a structure equal or similar to that of the first optical receiving parts 7 and 8. As shown in FIG. 2J or 2K, the optical waveguide 6 may have a transmission structure of the optical signal and the electrical signal.

An electrical signal that starts the operation of the image sensor 1 may be converted into an optical signal in the second optical transmitting parts 73 and 74 to transmit the converted optical signal to the second optical receiving parts 77 and 78 through the optical waveguide 6. The optical signal may be restored to the electrical signal in the second optical receiving parts 77 and 78 and transmitted to the image sensor 1 to operate the image sensor 1. A video signal and a clock signal that are an electrical signal generated by the operation of the image sensor 1 may be converted into an optical signal in the first optical transmitting parts 3 and 4 to transmit the converted optical signal to the first optical receiving parts 7 and 8 through the optical waveguide 6. The optical signal may be restored to the electrical signal in the first optical receiving parts 7 and 8 and transmitted to the ISP 10 to convert the restored electrical signal into a signal that is visually displayable.

An electrical interconnection 79 providing a path for transmitting the electrical signal needed to operate the image sensor 1 to the second optical transmitting parts 73 and 74 and an electrical interconnection 71 providing a transmission path from the second optical receiving parts 77 and 78 to the image sensor 1 may be disposed on the board 19. The first embodiment may be applicable to this embodiment except the above-described structure.

The optical interconnection unit 5h of the this embodiment includes at least three channels (dot line) in one optical waveguide 6 as an example such that the optical interconnection unit 5h is utilized for optical communication of the video and clock signals and the operation signal of the image sensor 1. In another example, two optical waveguides are provided, and thus, one optical waveguide may be utilized for optical communication of the video and clock signals, and the other optical waveguide may be utilized for optical communication of the operation signal of the image sensor 1.

The optical interconnection unit 5h that enables the bidirectional communication may be applicable to all embodiments of this application as well as this embodiment. The optical interconnection unit 5h may have a module type structure as shown in FIGS. 9A through 9C or FIGS. 10A and 10B.

### Fifteenth Embodiment

FIG. 16A is a plan view of a digital camera module according to a fifteenth embodiment of the inventive concept, and FIG. 16B is a perspective view of the digital camera module.

Referring to FIGS. 16A and 16B, a digital camera module 1500 of the fifteenth embodiment may further include a display module 150 electrically connected to the digital camera module 1400 of the fourteenth embodiment. The digital camera module 1400 described with reference to FIGS. 15A and 15B may be equally applicable to the digital camera module 1400. Also, the display module 150 described with reference to FIGS. 11A and 11B may be equally applicable to the display module 150. For another example, an ISP 10 may not be provided in the digital camera module 1400, but be provided in the display module 150 or integrally designed with a third semiconductor chip 33.

According to the above-described embodiments, the digital camera module may include the optical interconnection unit to transmit the signal generated in the image sensor to the ISP at a high speed and with large capacity. Therefore, the limitations of the signal transmission such as electromagnetic interface (EMI), impedance mismatch, skew, crosstalk, electromagnetic compatibility (EMC), and transmission losses may be overcome, and simultaneously, the data having high capacity may be transmitted at the high speed.

The above-disclosed subject matter is to be considered illustrative and not restrictive, and the appended claims are intended to cover all such modifications, enhancements, and other embodiments, which fall within the true spirit and scope of the inventive concept. Thus, to the maximum extent allowed by law, the scope of the inventive concept is to be determined by the broadest permissible interpretation of the following claims and their equivalents, and shall not be restricted or limited by the foregoing detailed description.

What is claimed is:

1. A digital camera module comprising:
an image sensor generating an electrical signal comprising a video signal and a clock signal; and
an optical interconnection unit converting the at least one of the video and clock signals into an optical signal to transmit the converted optical signal.

2. The digital camera module of claim 1, wherein the optical interconnection unit comprises:
a flexible optical waveguide providing a transmission path of the optical signal;
an optical transmitting part converting the at least one of the video and clock signals into the optical signal to transmit the converted optical signal to the optical waveguide; and
an optical receiving part restoring the optical signal transmitted from the optical waveguide to the electrical signal.

3. The digital camera module of claim 2, further comprising an image signal processor receiving the signal restored from the optical signal to the electrical signal to convert the received signal into a signal that is visually displayable.

4. The digital camera module of claim 2, wherein the optical transmitting part and the optical receiving part have module type structures separably coupled to the optical waveguide, respectively.

5. The digital camera module of claim 2, wherein the optical interconnection unit further comprises an electrical interconnection outside or inside the optical waveguide.

6. The digital camera module of claim 2, wherein the optical waveguide comprises one of an optical fiber, a core-clad waveguide in which a dielectric is built in an organic or inorganic polymer optical material, and a metal wire waveguide in which a metal wire is built in the polymer optical material.

7. The digital camera module of claim 1, wherein the optical interconnection unit comprises:
a first optical transmitting part converting the video and clock signals into a first optical signal;
a first optical receiving part restoring the first optical signal to a first electrical signal;
a second optical transmitting part converting an operation signal of the image sensor into a second optical signal; and
an optical waveguide providing a transmission path of the first and second optical signals,
wherein the first optical transmitting part and the second optical receiving part are disposed at one end of the optical waveguide, and the first optical receiving part and the second optical transmitting part are disposed at the other end of the optical waveguide.

8. The digital camera module of claim 1, further comprising:
a display visually displaying an image obtained from the image sensor; and
a display module comprising a semiconductor chip controlling an operation of the display.

9. A digital camera module comprising:
an image sensor mounted on a board comprising an electrical connection part, the image sensor photographing an image to generate an electrical signal comprising a video signal and a clock signal;
an image signal processor mounted on the board, the image signal processor converting the electrical signal into a signal that is visually displayable; and
an optical interconnection unit mounted on the board, the optical interconnection unit converting the electrical signal into an optical signal to transmit the converted optical signal from the image sensor to the image signal processor.

10. The digital camera module of claim 9, wherein the optical interconnection unit comprises:
an optical transmitting part comprising a light source and a light source driver chip, the optical transmitting part receiving the video and clock signals from the image sensor to convert the received signals from the electrical signal to the optical signal;
an optical waveguide providing a transmission path of the video and clock signals converted into the optical signal; and
an optical receiving part comprising a light receiving device and a light receiving device driver chip, the optical receiving part restoring the video and clock signals converted into the optical signal to the electrical signal.

11. The digital camera module of claim 10, wherein the optical interconnection unit further comprises:
an optical transmitting connector allowing the optical transmitting part to be separably coupled to the optical waveguide; and
an optical receiving connector allowing the optical receiving part to be separably coupled to the optical waveguide.

12. The digital camera module of claim 10, wherein the board comprises:
a first electrical interconnection providing a transmission path of the video and clock signals from the image sensor to the optical interconnection unit;
a second electrical interconnection providing a transmission path of the video and clock signals from the optical interconnection unit to the image signal processor; and
a third electrical interconnection providing a transmission path of the video and clock signals from the image signal processor to the electrical connection part.

13. The digital camera module of claim 9, further comprising a display module displaying an image photographed by the image sensor,
wherein the display module comprises:
a display board comprising an electrical connector electrically connected to the electrical connection part;
a display mounted on the display board, the display receiving the signal that is visually displayable from the image signal processor to display the signal; and
a semiconductor chip mounted on the display board, the semiconductor chip controlling an operation of the display module.

14. A digital camera module comprising:
an image sensor photographing an image to generate an electrical signal comprising a video signal and a clock signal; and
an optical interconnection converting the electrical signal into an optical signal to provide a transmission path of the optical signal,
wherein the optical interconnection unit comprises:
an optical waveguide providing a transmission path of the video and clock signals converted into the optical signal;
an optical transmitting module comprising a light source and a light source driver chip, the optical transmitting module receiving the video and clock signals from the image sensor to convert the received signals from the electrical signal to the optical signal; and
an optical receiving module comprising a light receiving device and a light receiving driver chip, the optical receiving module restoring the video and clock signals converted into the optical signal to the electrical signal;
wherein the optical transmitting and receiving modules are separably coupled to the optical waveguide.

15. The digital camera module of claim 14, wherein the optical waveguide comprises:
an optical interconnection providing a transmission path of the optical signal in the optical waveguide; and
an electrical interconnection providing a transmission path of an electrical signal needed to operate the image sensor inside or outside the optical waveguide.

16. The digital camera module of claim 14, further comprising a display module displaying an image photographed by the image sensor,
wherein the display module comprises:
a display board comprising an electrical connector electrically connected to the optical receiving module;
an image signal processor mounted on the display board, the image signal processor converting the video and clock signals into a signal that is visually displayable;
a display mounted on the display board, the display receiving the signal that is visually displayable from the image signal processor to display the signal; and
a semiconductor chip mounted on the display board, the semiconductor chip controlling an operation of the display module.

17. A digital camera module comprising:
an image sensor receiving a first electrical signal and photographing an image to generate a second electrical signal comprising a video signal and a clock signal; and
an optical interconnection unit comprising an optical transmitting part converting the electrical signals into optical signals, an optical receiving part restoring the optical signals to the electrical signals, and an optical waveguide providing a transmission path of the optical signals,
wherein the optical transmitting part comprises a first optical transmitting part converting the first electrical signal into a first optical signal and a first optical receiving part restoring the first optical signal to the first electrical signal, and
wherein the optical receiving part comprises a second optical transmitting part converting the second electrical signal into a second optical signal and a second optical receiving part restoring the second optical signal to the second electrical signal.

18. The digital camera module of claim 17, wherein the first optical transmitting part and the second optical receiving part are coupled to one end of the optical waveguide adjacent to the image sensor, and the first optical receiving part and the second optical transmitting part are coupled to the other end of the optical waveguide.

19. The digital camera module of claim 18, further comprising an image signal processor disposed adjacent to the other end of the optical waveguide to receive a signal restored from the second optical signal to the second electrical signal, thereby converting the received signal into a signal that is visually displayable.

20. The digital camera module of claim 17, further comprising:
a display visually displaying an image photographed by the image sensor; and
a display module comprising a semiconductor chip providing the first electrical signal to the image sensor to control an operation of the image sensor.
